(19) United States
(12) Patent Application Publication
(10) Pub. No.: US 2026/0302170 A1
(43) Pub. Date: Oct. 1, 2026

(54) ALLOY ELECTRODES FOR ALL SOLID STATE BATTERIES AND METHODS OF MAKING SAME

(71) Applicants: LG Energy Solution, Ltd., Seoul (KR); The Regents of the University of California, Oakland, CA (US)

(72) Inventors: Jung-Pil Lee, Daejeon (KR); Dayoung Kim, Daejeon (KR); Ji Young Kim, Daejeon (KR); Zheng Chen, San Diego, CA (US); Dongju Lee, La Jolla, CA (US); Yuju Jeon, La Jolla, CA (US)

(21) Appl. No.: 19/092,684

(22) Filed: Mar. 27, 2025

(51) Int. Cl. H01M 4/134; H01M 4/02; H01M 4/04; H01M 4/1395; H01M 4/40; H01M 4/46; H01M 4/62; H01M 10/0525

(52) U.S. Cl. CPC H01M 4/134; H01M 4/043; H01M 4/0495; H01M 4/1395; H01M 4/405; H01M 4/463; H01M 4/622; H01M 10/0525; H01M 2004/027

(57) ABSTRACT

An anode layer is disclosed. The anode layer includes a polymer binder and particles LiAl-containing particles. The anode layer has a first surface and a second surface facing away from the first surface. Along a general direction from the first surface to the second surface, amounts of Li in the LiAl-containing particles generally increase, sizes of the LiAl-containing particles generally become smaller, and shapes of the LiAl-containing particles change from generally round to irregular shapes with sharp edges. Molecules of the polymer binder are distributed generally throughout the anode layer and surround at least part of the LiAl-containing particles.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure relates to alloy electrodes, particularly, lithium-aluminum (LiAl) alloy anodes and/or anode layers, for all solid state batteries, and methods of making anodes and/or anode layers.

### Secondary Batteries

Secondary batteries have become increasingly desirable power sources for a wide range of various electronic devices, such as cars, computers, cell phones, tools, scooter, bikes, electronic automobiles, power storage systems, drones, and other devices. Among secondary batteries, lithium-based batteries have gained particular prominence due to their ability to provide a desirable balance of voltage and energy density. Traditionally, lithium secondary batteries include a liquid electrolyte, typically comprising a lithium salt dissolved in an organic solvent. However, there has been growing interest in developing an all solid-state lithium secondary battery as an alternative to conventional liquid electrolyte-based systems. Solid-state batteries offer potential advantages in terms of safety, stability, and energy density. Despite these potential benefits, the development of practical all solid-state lithium secondary batteries faces several significant challenges.

### Challenges of All Solid-State Secondary Batteries

One challenge in solid-state battery design is achieving and maintaining sufficient lithium ion diffusivity within the solid electrolyte material. Further, volume changes (e.g. swelling and shrinking) of certain components of the battery—such as the electrode—may occur during discharging and charging of the battery. These volume changes may lead to mechanical stress or result in a loss of contact between various components within the battery structure. The loss of contact between battery components can cause degradation of charging and discharging characteristics, as well as deterioration of overall battery capacity. Researchers and engineers in the field of energy storage are actively working to address these challenges. Efforts are focused on developing new materials and battery designs that can achieve desirable lithium ion diffusivity while also accommodating the mechanical stresses associated with battery cycling. Improving the stability of interfaces within solid-state batteries remains an area of investigation. Overcoming the current limitations of solid-state battery systems could potentially lead to significant advancements in energy storage capabilities for a wide range of applications.

### Alloy Electrodes

Alloy electrodes have emerged as a promising category for all-solid-state batteries due to their potential to deliver higher energy densities while offering intrinsic safety advantages. These electrodes operate based on the reversible alloying and dealloying reactions between lithium and a host metal, a mechanism that can enable high specific capacities and improved electrochemical performance compared to traditional intercalation-type electrodes. In all-solid-state battery systems, the integration of alloy electrodes can further enhance stability and safety by eliminating flammable liquid electrolytes, thereby reducing risks associated with dendrite formation and thermal runaway.

### Li—Al Alloy Anode

Among the various alloy systems, the Li—Al alloy anode has attracted significant attention. The Li—Al system offers a compelling balance between energy density and material availability, as aluminum is both abundant and cost-effective. In this alloy, lithium is reversibly incorporated into the aluminum matrix, leading to the formation of various intermetallic phases. This reversible alloying reaction is capable of delivering a high theoretical capacity, making the Li—Al alloy anode a strong candidate for high-performance all-solid-state batteries. Moreover, the Li—Al alloy benefits from the intrinsic stability provided by the solid electrolyte environment, which can enable more robust cycling performance and longer battery lifetimes compared to systems using conventional liquid electrolytes.

### Design of Alloy Electrodes

The design of alloy electrodes, and particularly the Li—Al alloy anode, involves careful consideration of material composition and structural integration to maximize the efficiency of lithium storage and retrieval. Researchers have explored various electrode architectures, including nanostructured forms and composite configurations, to optimize both the electrochemical kinetics and the mechanical integrity of the electrode. The goal is to ensure that the alloy electrode not only offers high capacity and energy density but also maintains stable and uniform reaction pathways throughout repeated cycling.

### Benefits of Alloy Electrodes

In summary, alloy electrodes offer a transformative approach to all-solid-state battery design by leveraging the high capacity and favorable electrochemical properties of alloying reactions. The Li—Al alloy anode, with its high theoretical capacity and the benefits of aluminum's abundance and cost-effectiveness, stands out as a particularly promising candidate for next-generation energy storage applications. Its integration into all-solid-state battery systems could pave the way for safer, more efficient, and longer-lasting batteries that meet the growing demands of modern electronic and electric vehicle technologies.

### No Admission of Prior Art

The discussion in this section is intended to provide background information related to the present disclosure and does not constitute an admission of prior art.

### SUMMARY

### Anode

One aspect of the present disclosure provides an anode. The anode includes a current collector and an anode active material layer. The anode active material layer includes a polymer binder and particles containing lithium-aluminum alloy (LiAl) (hereinafter “LiAl-containing particles”). The anode active material layer has a first surface facing away from the current collector and a second surface facing the current collector. The closer to the second surface along a direction from the first surface to the second surface within the anode active material layer, generally the more lithium the LiAl-containing particles contain. The closer to the second surface along the direction within the anode active material layer, generally the smaller the LiAl-containing particles are. The closer to the second surface along the direction within the anode active material layer, generally the less round the LiAl-containing particles are. Further, molecules of the polymer binder are distributed generally throughout the anode active material layer such that a portion of at least part of the molecules of the polymer binder is interposed between two adjacent LiAl-containing particles within the anode active material layer.

### Surfaces

In some embodiments, the anode layer provided herein further comprises Al particles on the first surface. In some embodiments, the anode layer provided herein further comprises Li metal on the second surface.

### Molar Ratio

In some embodiments, the LiAl-containing particles have a Li:Al molar ratio of from about 0.1 to about 5. In some embodiments, the LiAl-containing particles have a Li:Al molar ratio of from about 0.5 to about 1. In some embodiments, the LiAl-containing particles have a Li:Al molar ratio of from about 0.5.

### Polymer Binder

In some embodiments, the polymer binder comprises at least one polymer selected from the group consisting of polyvinylidene fluoride (PVDF), polyvinyl alcohol (PVA), polyethylene oxide (PEO), polyacrylonitrile (PAN), polyimide (PI), carboxymethyl cellulose (CMC), succinonitrile-based polymers, styrene-butadiene rubber (SBR), polyethylene glycol (PEG), polyvinyl acetate (PVAc), polyurethane (PU), polyacrylic acid (PAA), ionic polymers, gel polymers, hydroxypropyl methylcellulose, methyl cellulose, starch, modified starches, and acrylic emulsion polymers.

### Method of Making Anode

Another aspect of the present disclosure provides a method of making an anode. An Al-containing film comprising Al particles and a polymer binder is provided and overlaid on top of a Li foil which is overlaid on top of a current collector, such that a surface of the Al-containing film and a surface of the Li foil contact each other. Then, the Al-containing film and the Li foil are pressed together on top of the current collector to form the anode, such that at least part of Li metal in the Li foil moves toward the Al-containing film, at least part of the Al particles in the Al-containing film move toward the Li foil, and the Li metal contacts surfaces of the Al particles to form particles containing lithium-aluminum alloy (LiAl) (hereinafter “LiAl-containing particles”). The anode includes a current collector and an anode active material layer. The anode active material layer includes a polymer binder and particles containing lithium-aluminum alloy (LiAl) (hereinafter “LiAl-containing particles”). The anode active material layer has a first surface facing away from the current collector and a second surface facing the current collector. The closer to the second surface along a direction from the first surface to the second surface within the anode active material layer, generally the more lithium the LiAl-containing particles contain. The closer to the second surface along the direction within the anode active material layer, generally the smaller the LiAl-containing particles are. The closer to the second surface along the direction within the anode active material layer, generally the less round the LiAl-containing particles are. Further, molecules of the polymer binder are distributed generally throughout the anode active material layer such that a portion of at least part of the molecules of the polymer binder is interposed between two adjacent LiAl-containing particles within the anode active material layer.

### Preparing Al-Containing Film

In some embodiments, the method provided herein further comprises preparing the Al-containing film. A solution or slurry comprising the Al particles, a solvent, and the polymer binder is first prepared. Then, a layer of the solution or slurry is provided on top of a substrate and dried to form the Al-containing film, which has a substantially homogenous thickness.

### Binder

In some embodiments, the polymer binder comprises at least one polymer selected from the group consisting of polyvinylidene fluoride (PVDF), polyvinyl alcohol (PVA), polyethylene oxide (PEO), polyacrylonitrile (PAN), polyimide (PI), carboxymethyl cellulose (CMC), succinonitrile-based polymers, styrene-butadiene rubber (SBR), polyethylene glycol (PEG), polyvinyl acetate (PVAc), polyurethane (PU), polyacrylic acid (PAA), ionic polymers, gel polymers, hydroxypropyl methylcellulose, methyl cellulose, starch, modified starches, and acrylic emulsion polymers. In some embodiments, the polymer binder is in an amount of about 0.1~10 wt % based on a total weight of the Al powder.

### Thickness of Li Foil

In some embodiments, the Li foil has a thickness from about 0.1 μm to about 10 μm.

### Conditions

In some embodiments, the Al-containing film and the Li foil are pressed under a pressure from about 100 MPa to about 500 MPa. The method of claim 8, wherein the Al-containing film and the Li foil are pressed under a pressure from about 125 MPa to about 400 MPa. In some embodiments, the Al-containing film and the Li foil are pressed for about 5 minutes to about 1 hour. In some embodiments, the Al-containing film and the Li foil are pressed for about 10 minutes to about 30 minutes. In some embodiments, the Al-containing film and the Li foil are pressed at a temperature from about 20° C. to about 150° C. In some embodiments, the Al-containing film and the Li foil are pressed at a temperature from about 50° C. to about 100° C.

### All-Solid-State Battery

Yet another aspect of the present disclosure provides an all-solid-state battery comprising: an anode; a cathode; and a solid electrolyte positioned between the cathode and the anode and configured to enable transport of lithium ions between the cathode and the anode The anode includes a current collector and an anode active material layer. The anode active material layer includes a polymer binder and particles containing lithium-aluminum alloy (LiAl) (hereinafter “LiAl-containing particles”). The anode active material layer has a first surface facing away from the current collector and a second surface facing the current collector. The closer to the second surface along a direction from the first surface to the second surface within the anode active material layer, generally the more lithium the LiAl-containing particles contain. The closer to the second surface along the direction within the anode active material layer, generally the smaller the LiAl-containing particles are. The closer to the second surface along the direction within the anode active material layer, generally the less round the LiAl-containing particles are. Further, molecules of the polymer binder are distributed generally throughout the anode active material layer such that a portion of at least part of the molecules of the polymer binder is interposed between two adjacent LiAl-containing particles within the anode active material layer.

### Exemplary Embodiments

These and other features of the present disclosure may be understood from the following detailed description and will become more fully apparent from the exemplary embodiments of the present disclosure. Also, it will be easily understood that the objects and advantages of the present disclosure may be realized by the means shown in the appended claims and combinations thereof.

### Summary Not Limiting

It is understood that this disclosure is not limited to the examples summarized in this Summary. Various other aspects are described and exemplified herein.

### BRIEF DESCRIPTION OF THE DRAWINGS

FIG. 1 illustrate an example process of making an example alloy anode using an embodiment of the method provided herein.

FIG. 2 illustrate an example process of making an example alloy anode using another embodiment of the method provided herein.

FIG. 3 is a scanning electron microscope (SEM) image of a portion of a cross-section of the example anode made by the embodiment of the method illustrated in FIG. 2.

FIG. 4 illustrates the morphology of the portion of the cross-section of the example anode in FIG. 3.

FIG. 5 is an example of an all solid state battery according to one embodiment.

FIG. 6 shows XRD spectra of the Al-containing film of Example 1.1 and the LiAl anode of Example 1.4.

FIG. 7 is a SEM image of the anode of Example 1.4.

FIG. 8 is the XRD spectra of the Al-containing films of Example 2.1 and the LiAl anodes of Example 2.4.

FIG. 9 shows the CCD test results of the battery of Example 3.1.

FIG. 10 shows the CCD test results of the battery of Example 4.1.

### EXEMPLIFICATIONS NOT LIMITING

The exemplifications set out herein illustrate certain non-limiting embodiments, in one form, and such exemplifications are not to be construed as limiting the scope of the appended claims in any manner.

### DETAILED DESCRIPTION

### Examples and Embodiments

The presently disclosed subject matter now will be described and discussed in more detail in terms of some specific embodiments and examples with reference to the accompanying drawings, in which some, but not all embodiments of the invention are shown. Like numbers refer to like elements or parts throughout unless otherwise referenced. The presently disclosed subject matter may be embodied in many different forms and should not be construed as limited to the specific embodiments set forth herein. Rather, these embodiments are provided so that this disclosure will satisfy applicable legal requirements. Indeed, many modifications and other embodiments of the presently disclosed subject matter will come to the mind of one skilled in the art to which the presently disclosed subject matter pertains. Therefore, it is to be understood that the presently disclosed subject matter is not to be limited to the specific embodiments disclosed and that modifications and other embodiments are intended to be included within the scope of the appended claims.

### Claim Interpretation

Hereinafter, the present disclosure will be described in detail. It should be understood that the terms or words used in the specification and the appended claims should not be construed as limited to general and dictionary meanings, but rather interpreted based on the meanings and concepts corresponding to the technical aspects of the present disclosure on the basis of the principle that the inventor is allowed to define terms appropriately for the best explanation. Therefore, the aspects of the disclosure described herein and the elements shown in the drawings are just aspects of the present disclosure, but not intended to fully describe the technical aspects of the present disclosure, so it should be understood that other equivalents and modifications could have been made thereto at the time the application was filed.

### Technical Terms

Unless defined otherwise, all the technical and scientific terms used herein have the same meanings as commonly known by a person skilled in the art. In the case that there is a plurality of definitions for the terms herein, the definitions provided herein will prevail.

### Definitions

### “A,” “An” and “The”

As used herein, the singular form of a word includes the plural, unless the context clearly dictates otherwise. The plural encompasses the singular and vice versa. Thus, the references “a,” “an” and “the” are generally inclusive of the plurals of the respective terms. For example, while the present disclosure has been described in terms of “a” layer, “a” substrate, “a” cell, and the like, more than one of these and other components, including combinations, can be used.

### “About”, “Approximately”, and “Substantially”

The term “about” indicates and encompasses an indicated value and a range above and below that value. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. In certain embodiments, the term “about” indicates the designated value ±10%, ±5%, or ±1%. In certain embodiments, the term “about” indicates the designated value ±one standard deviation of that value.

### “Comprise,” “Consisting Essentially Of”, and “Consisting Of”

The words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may or may not lack any element that is not specifically disclosed herein. Thus, a disclosure of an embodiment defined using the term “comprising” is also a disclosure of embodiments “consisting essentially of” and “consisting of” the disclosed components. The phrase “consisting essentially of” limits the scope of the disclosed components to the specified materials or steps and those that do not materially affect the basic and novel characteristics of the disclosed invention. The phrase “consisting of” excludes any element, step, or ingredient not specified.

### “And/Or”

The term “and/or” used in the context of “X and/or Y” should be interpreted as “X,” “Y,” or “X and Y.”

### “On” and “Over”

As used herein, the terms “on,” “applied over,” “applied on,” “formed over,” “formed on, “deposited over,” “deposited on,” “overlay,” “provided over,” “provided on,” and the like, mean formed, overlaid, deposited, or provided on but not necessarily in contact with the surface. For example, a formed layer “applied over” a substrate layer does not preclude the presence of one or more other layers of the same or different composition located between the formed layer and the substrate layer.

### Markush Group

As used herein, the term “combination thereof” included in any Markush-type expression means a combination or mixture of one or more elements selected from the group of elements disclosed in the Markush-type expression, and refers to the presence of one or more elements selected from the group. The term “combinations thereof” includes every possible combination of elements to which the term refers.

### “Between”

As used herein, the expression “between” is inclusive of end points.

### Numerical Ranges

Furthermore, all numerical ranges herein should be understood to include all integers, whole or fractions, within the range. Moreover, any numerical range recited herein is intended to include all sub-ranges subsumed therein, and these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth. When ranges are given, any endpoints of those ranges and/or numbers within those ranges can be combined with the scope of the present disclosure.

### Precision of Numbers

As used herein, unless otherwise expressly specified, all numbers, such as those expressing values, ranges, amounts, or percentages, may be read as if prefaced by the word “about,” even if the term does not expressly appear. “Including,” “such as,” “for example,” and like terms mean “including/such as/for example but not limited to.”

### Combination of Embodiments

As used herein, the term “example,” particularly when followed by a listing of terms, is merely exemplary and illustrative, and should not be deemed to be exclusive or comprehensive. Any embodiment disclosed herein can be combined with any other embodiment disclosed herein unless explicitly indicated otherwise.

### Particle Size

As used herein, particle size refers to the mean particle diameter (D₅₀) as measured using microscopy (e.g., optical microscopy, electron microscopy, scanning electron microscopy (SEM), transmission electron microscopy (TEM), atomic force microscopy (AFM), confocal microscopy, or fluorescence microscopy). The size can be the diameter of spherical particles or the length along the largest dimension of ellipsoidal or otherwise irregularly shaped particles. As used herein, “D₅₀” of particles refers to the diameter at which 50% of the particles have a smaller diameter.

### Challenges of Li—Al Alloy Electrode

### Overview of Challenges

The Li—Al alloy electrode for all-solid-state batteries is challenged by significant volume expansion and mechanical stress, poor lithium-ion diffusion with phase separation issues, and problematic interfacial interactions with solid electrolytes. These challenges are compounded by the instability of lithium powder, the scaling difficulties of lithium and aluminum powders, the high density and lithiation limitations of aluminum foil, and the precision required for fabricating a uniform lithium film.

### Volume Expansion

The development of a Li—Al alloy electrode for all-solid-state batteries is fraught with a complex array of technical challenges that stem from both intrinsic material properties and processing limitations. One of the foremost challenges is the significant volume expansion experienced during lithium insertion and extraction. The alloying reaction between lithium and aluminum can result in a volumetric change of up to approximately 200%, generating substantial mechanical stress. This expansion and contraction cycle may induce cracking and structural degradation of the electrode over repeated cycles, thereby undermining both its mechanical integrity and long-term electrochemical performance.

### Poor Lithium-Ion Diffusion

Coupled with these mechanical issues is the challenge of poor lithium-ion diffusion within the aluminum matrix. Aluminum inherently exhibits a low lithium-ion diffusion coefficient, which impedes rapid charge and discharge capabilities. The situation is further complicated by the formation of multiple LiₓAl phases—such as LiAl, Li₃Al₂, and Li₉Al₄—during cycling. The resultant phase separation can lead to heterogeneous lithium distribution within the electrode, creating regions with poor electrical connectivity and increased internal resistance. These inhomogeneities in lithium transport exacerbate the overall degradation of the electrode's performance.

Interface with Solid Electrolyte

Additional complications arise at the interface between the Li—Al alloy electrode and the solid electrolyte. The dynamic volume changes in the electrode can disrupt physical contact with the solid electrolyte, resulting in increased interfacial resistance and diminished ion transport efficiency. Moreover, certain solid electrolytes, especially those based on sulfide chemistries, may react with the Li—Al alloy to form resistive interphase layers. Such chemical interactions not only impede lithium-ion movement but also contribute to the deterioration of battery performance over time.

### Challenges of Powder Precursor Materials

The challenges extend beyond the alloy itself to the precursor materials and fabrication processes. Lithium powder, for instance, is inherently unstable due to its high reactivity and susceptibility to rapid oxidation upon exposure to even trace amounts of moisture or oxygen. This instability demands stringent inert atmosphere conditions during processing, significantly complicating manufacturing operations and elevating production costs. In addition, both lithium and aluminum powders present substantial scaling challenges. Achieving a consistent particle size distribution and controlled surface reactivity on a commercial scale is difficult, and any variations can lead to inhomogeneous alloy formation. Such inconsistencies may result in localized regions with poor electrical connectivity and uneven mechanical stress distribution during cycling.

### Challenges of Layer Precursor Materials

Alternative approaches, such as employing aluminum foil as a precursor, also face critical limitations. The high density and crystalline nature of aluminum foil restrict effective lithium penetration during the lithiation process, leading to incomplete alloy formation and a heterogeneous distribution of the Li—Al alloy. This incomplete lithiation compromises the uniformity and performance of the resulting electrode. Similarly, the use of a lithium film, either as a precursor for alloy formation or as an integral component of the electrode, introduces its own set of challenges. The fabrication of a uniform lithium film demands precise control over deposition parameters. Even slight irregularities in film thickness or surface coverage can result in non-uniform alloying with aluminum, thereby exacerbating issues related to phase inhomogeneity and mechanical stress.

### Power and Powder

Using aluminum powder and lithium powder to fabricate an Al—Li alloy electrode for all-solid-state batteries introduces several significant challenges that stem from both the intrinsic reactivity of the powders and the complexities of their processing. The use of Al and Li powders necessitates stringent control over the processing environment—often requiring inert atmosphere conditions—and precise optimization of mixing, pressing, and sintering parameters.

### Chemical Reactivity

One of the foremost issues is their inherent chemical reactivity, particularly that of Li powder. Lithium powder is extremely sensitive to air and moisture, meaning that even trace amounts of oxygen or water vapor can lead to rapid oxidation. This oxidation not only degrades the active material but can also compromise the safety of the process by generating heat or even causing unwanted exothermic reactions. Similarly, although aluminum is less reactive than lithium, fine Al powders are prone to forming surface oxides that can hinder the subsequent alloying process by creating a passivation layer.

### Non-Uniformity

Another challenge arises from the difficulty of achieving a uniform distribution of the powders when they are mixed together. The differences in particle size, shape, and density between Al and Li powders can lead to agglomeration or uneven mixing, which in turn may result in an inhomogeneous alloy composition upon pressing or sintering. This non-uniformity can adversely affect the electrode's mechanical integrity and its electrochemical performance, as regions with an excess or deficiency of lithium may exhibit differing reaction kinetics or conductivity.

### Processing

The processing of powder-based electrodes also presents challenges during consolidation and sintering steps. Unlike continuous films, powders require careful control of the pressing parameters to achieve sufficient densification while avoiding the formation of voids or cracks. Poor interparticle connectivity can lead to high internal resistance and may reduce the efficiency of lithium diffusion during cycling. Furthermore, controlling the stoichiometry and ensuring intimate contact between the individual powder particles is more complex in powder systems, where the large surface area exacerbates issues related to oxidation and contamination.

### Film and Film

Using separate aluminum (Al) and lithium (Li) films to fabricate an Al—Li alloy electrode for all-solid-state batteries presents several interrelated challenges, spanning from material handling to interfacial chemistry and mechanical integrity. The challenges include controlling the uniformity and surface quality of the aluminum film, preventing oxidation and ensuring consistent film formation with the highly reactive lithium, achieving intimate and clean interfacial contact for effective alloying, and managing the mechanical stresses that arise during pressing and subsequent battery operation.

### Film Formation

One primary challenge with aluminum film is ensuring uniformity and purity during film formation. Aluminum films can be prone to surface oxidation during processing, which might interfere with subsequent alloying with lithium. Because aluminum is dense and relatively inert compared to lithium, achieving a uniform and defect-free film with consistent thickness and microstructure is essential. Any non-uniformity can lead to uneven lithium infiltration during the alloying process, which in turn could result in local regions with variable alloy composition and, ultimately, inconsistent electrochemical performance. Additionally, mechanical stresses during processing, for example, during lamination or pressing, can cause micro-cracking or delamination in the aluminum film, potentially degrading its structural integrity before or during the alloying step.

### Challenges of Lithium Film

Lithium film introduces its own set of challenges due to its inherent chemical reactivity and softness. Lithium is extremely reactive with moisture and oxygen, necessitating rigorous control of the processing environment (typically under inert atmosphere conditions) to prevent oxidation or contamination. Moreover, lithium films tend to be ductile and soft, making them difficult to handle without deforming. This softness can lead to challenges in achieving a uniform film with consistent thickness, and it also complicates the pressing process used to bring the Li film into intimate contact with the Al film. Under pressure, the lithium may not uniformly distribute across the interface; instead, it may form localized agglomerations or develop irregular morphologies, which in turn can result in non-uniform alloying and the formation of intermetallic phases with varied properties.

### Interface Contact

At the interface between the Al film and the Li film, ensuring robust, defect-free contact is critical for effective alloying. The pressing process must overcome surface roughness and any pre-existing oxide layers, allowing lithium atoms to diffuse into the aluminum lattice. However, if the interface is not sufficiently intimate or if the surfaces are contaminated, the diffusion of lithium into aluminum may be inhibited. This can lead to incomplete alloying and the potential formation of brittle intermetallic compounds, which may compromise the mechanical and electrochemical stability of the electrode.

### Dynamic Behavior

Furthermore, the dynamic behavior of both films during mechanical pressing introduces additional complexities. The differential mechanical properties of the two films—rigid aluminum versus soft lithium—can lead to uneven stress distributions and localized deformations. This not only affects the interdiffusion process but also raises concerns about long-term cycling stability, as repeated charge-discharge cycles can exacerbate any initial inhomogeneities created during processing.

### Foil and Foil

Using aluminum foil and lithium foil to fabricate an Al—Li alloy electrode for all solid state batteries presents a distinct set of challenges compared to other forms of these materials. The challenges include managing surface oxidation on aluminum, overcoming the low specific surface area and mechanical rigidity of the foil, handling the extreme reactivity and softness of lithium foil, and addressing the mechanical mismatch between the two. These factors complicate the formation of a uniform, defect-free alloy interface and require careful control of processing conditions, such as inert atmosphere handling, precise surface treatment, and optimized pressure application, to ensure a reliable electrode for all-solid-state battery applications.

### Challenges of Al Foil

One major issue with aluminum foil is that its high density and relatively low specific surface area can limit the extent and uniformity of lithiation. In many cases, a native oxide layer forms on the surface of the aluminum foil during storage or handling, which must be removed or sufficiently penetrated by lithium during the alloying process. This oxide layer can inhibit effective interdiffusion between the lithium and aluminum, leading to an uneven alloy composition. In addition, the mechanical rigidity of aluminum foil means that any pre-existing surface imperfections or non-uniformities can persist throughout processing, further complicating the formation of a homogeneous Li—Al alloy layer.

### Challenges of Li Foil

Lithium foil, by contrast, is characterized by its extreme chemical reactivity and softness. Due to its high reactivity, lithium foil is extremely sensitive to air and moisture; even minimal exposure can lead to oxidation or the formation of lithium compounds that compromise its purity. This reactivity necessitates stringent processing conditions, typically under an inert atmosphere, which increases complexity and cost. The soft, ductile nature of lithium foil also means that it is difficult to handle without deformation. During pressing or lamination with aluminum foil, the lithium may flow unevenly, creating localized regions where the lithium content is either excessive or insufficient. These nonuniformities can not only affect the stoichiometry of the resulting alloy but also lead to mechanical stress and potential delamination at the interface.

### Mismatch in Mechanical Properties

Furthermore, when combining a rigid material like aluminum foil with a much softer lithium foil, the differences in mechanical properties become critical during the pressing and alloying process. The mismatch in hardness can lead to nonuniform pressure distribution, causing uneven alloy formation and local stress concentrations. These factors can result in the formation of microcracks or voids, which adversely affect the electrochemical performance and long-term cycling stability of the battery. Finally, because both foils are used as continuous layers, ensuring intimate, defect-free contact along the entire interface is more challenging than in particulate or film-based systems.

### Lithium Plating and Dendritic Structures

Furthermore, non-uniform lithium deposition during cycling can lead to the formation of lithium plating and dendritic structures on the electrode surface. These dendrites may penetrate the solid electrolyte, posing significant safety risks due to potential short circuits. Maintaining a stable and uniformly lithiated electrode surface is therefore essential to ensure both safety and reliable long-term battery performance.

### Addressing Challenges

Addressing these multifaceted challenges will necessitate innovative manufacturing strategies and material modifications, such as nanostructuring to better accommodate volume changes, the use of buffer layers to enhance interfacial stability, and optimization of the Li:Al ratio. Such advancements are critical for achieving a commercially viable Li—Al alloy electrode for next-generation all-solid-state battery technologies.

### Method of Making Anode

One aspect of the present disclosure provides a method of making an anode comprising Li—Al alloy-containing particles and a polymer binder. The method includes providing an Al-containing film comprising Al particles and the polymer binder; overlaying the Al-containing film with a Li foil which is overlaid on top of a current collector, such that a surface of the Al-containing film and a surface of the Li foil contact each other; and pressing the Al-containing film and the Li foil together to form the anode provided herein, such that at least part of Li metal in the Li foil moves toward the Al-containing film, such that at least part of the Al particles in the Al-containing film move toward the Li foil, and such that the Li metal contacts surfaces of the Al particles to form the LiAl-containing particles. The method provided herein improves the safety and processability of electrode manufacturing and the performance of the manufactured electrode and battery including such electrode.

### Making Al-Containing Film

Al-Containing film

The Al-containing film may be made using Al powder via wet casting. It involves preparing a well-dispersed slurry of aluminum powder with appropriate binders and solvents, casting the slurry onto a substrate using techniques like doctor blade or tape casting, and then carefully drying the film to form a continuous layer. Post-processing steps such as sintering may be applied to enhance film properties, followed by comprehensive characterization to verify quality. This process requires precise control over formulation, casting, and thermal treatment parameters to produce a high-quality aluminum film suitable for further applications.

### Powder Preparation and Formulation of Slurry

Initially, high-purity aluminum powder is selected, ensuring that the particle size distribution is appropriate for forming a dense film. The aluminum powder is then mixed with a suitable solvent—often water or an organic solvent—and a binder system. The binder serves to hold the powder particles together after drying. Dispersants or surfactants may also be added to improve the homogeneity of the slurry and prevent agglomeration of the aluminum particles. This mixture is vigorously stirred, sometimes with the aid of ultrasonic agitation or high-shear mixers, to ensure that the aluminum powder is well dispersed throughout the solvent, resulting in a stable, uniform slurry.

### Rheology Adjustment

The slurry's viscosity is critical for the subsequent casting process. Adjustments may be made by controlling the concentration of the aluminum powder, binder, and solvent. If necessary, additional rheology modifiers are introduced to achieve a viscosity that is low enough to allow for smooth spreading but high enough to prevent sedimentation of the particles during casting. Optimizing these parameters ensures that the slurry can be cast into a film of uniform thickness.

### Casting Process

Once the slurry is prepared and its rheology is optimized, the wet casting process begins. A common method for producing films is the doctor blade technique. In this method, the slurry is deposited onto a substrate—often a smooth, non-stick surface or a carrier foil—and a doctor blade is used to spread the slurry evenly over the substrate at a controlled thickness. The gap between the doctor blade and the substrate is carefully set to achieve the desired film thickness. Alternative casting methods such as slot-die coating or tape casting may also be employed, depending on the scale and desired properties of the film.

### Drying

After casting, the wet film is allowed to dry. Drying is a critical step, as it must remove the solvent uniformly without causing cracks or non-uniformities in the film. The drying process can be conducted under controlled temperature and humidity conditions. In some cases, the film may be passed through a drying oven or a controlled environment chamber to ensure that the solvent evaporates at a steady rate, leaving behind a solid film of aluminum powder bound by the polymer matrix.

### Post-Processing

Further post-processing steps may be required. If a more conductive or mechanically robust film is needed, the dried film may undergo sintering—a thermal process that causes the aluminum particles to fuse together. Sintering temperatures are selected carefully to promote neck formation between particles without melting the binder or causing oxidation of the aluminum. In some cases, a reducing atmosphere (such as forming gas, a mixture of hydrogen and nitrogen) might be used during sintering to minimize the formation of aluminum oxide. Alternatively, other consolidation techniques such as hot pressing may be applied to improve film density and mechanical properties.

### Al Powder Particle Size

The particle size of the Al powder directly influences the uniformity, density, and electrochemical performance of the final electrode. Selecting the appropriate particle size ensures good packing density, smooth film formation, and efficient lithium diffusion during alloying. Fine aluminum powders with a particle size of up to 5 μm, such as 0.1 to 5 μm, provide a high surface area, which enhances sintering and facilitates lithium diffusion. However, these ultra-fine particles are highly reactive and prone to oxidation, requiring careful handling and processing in an inert atmosphere. Medium-sized aluminum powders, typically with a particle size ranging from 5 to 20 μm, offer a balance between packing density and processability. They reduce the risk of excessive oxidation while maintaining film uniformity, making them a practical choice for electrode fabrication. Coarser aluminum powders in the range of larger than 20 μm, such as 20 to 50 μm, improve the mechanical strength of the film but may lead to lower surface area availability for lithiation, potentially affecting alloying efficiency.

### Controlled Particle Size Distribution

Achieving an optimal balance often involves using a controlled particle size distribution. A bimodal or multimodal size distribution, combining smaller particles in the range of 1 to 5 μm with larger particles around 10 to 20 μm, can enhance film compaction and uniformity while maintaining adequate lithium diffusion pathways. The selection of particle size also affects the film's smoothness, as uncontrolled size variation can lead to surface roughness and defects, impacting lithium penetration and alloying kinetics.

### Selecting Particle Size

The careful selection of particle size, combined with optimized processing conditions, ensures that the final Al—Li alloy anode meets the performance requirements necessary for high-efficiency all-solid-state battery applications. Al powders in the range of 5 to 20 μm may be selected, as they provide a good compromise between smooth film formation, efficient lithium alloying, and manufacturability. For example, the Al powder may have a particle size at or about 5, 6, 7, 8, 9, 10, 11, 12, 13, 14, 15, 16, 17, 18, 19, or 20 μm. In embodiments, the Al powder may have a particle size within a range formed by selecting any two numbers provided herein, for example, from about 5 to about 10, from about 10 to about 15, from about 15 to about 20, from about 8 to about 18 μm, etc. Al powders smaller than 5 μm and/or larger than 20 μm may also be selected in different embodiments. For example, the Al powder may have a particle size at or about 0.01, 0.1, 1, 2, 3, 4, 21, 22, 23, 25, 26, 27, 28, 29, 30, 31, 32, 33, 34, 35, 36, 37, 38, 39, 40, 41, 42, 43, 44, 45, 46, 47, 48, 49, 50, 55, 60, 65 μm, etc. In embodiments, the Al powder may have a particle size within a range formed by selecting any two numbers provided herein, for example, from about 0.01 to about 1, from about 2 to about 5, from about 20 to about 30, from about 50 to about 60 μm, etc.

### Binder

The binder must facilitate the formation of a continuous, uniform Al film. It should promote good adhesion among aluminum particles and between the film and the casting substrate, ensuring that the as-cast film exhibits the mechanical integrity necessary for subsequent handling and processing. The binder must be chemically inert with respect to both the aluminum powder and any other additives in the slurry. Moreover, it should not introduce contaminants that could interfere with the subsequent lithiation process or the formation of a uniform Li—Al alloy. The binder and any residues must be compatible with the solid electrolyte environment and cannot leave behind residues detrimental to ionic conductivity or that might react with the solid electrolyte materials.

### Materials for Binder

The binder may be a polymer, such as one or more of polyvinylidene fluoride (PVDF), polyvinyl alcohol (PVA), polyethylene oxide (PEO), polyacrylonitrile (PAN), polyimide (PI), carboxymethyl cellulose (CMC), succinonitrile-based polymers, styrene-butadiene rubber (SBR), polyethylene glycol (PEG), polyvinyl acetate (PVAc), polyurethane (PU), polyacrylic acid (PAA), ionic polymers, gel polymers, hydroxypropyl methylcellulose, methyl cellulose, starch, modified starches, and acrylic emulsion polymers. For example, PVA is frequently used because of its excellent film-forming properties and water solubility. CMC provides good viscosity control and dispersion of aluminum particles. Cellulose derivatives, such as hydroxypropyl methylcellulose and methyl cellulose, are valued for their film-forming capabilities and are generally biodegradable. Starch and modified starches are eco-friendly. Acrylic emulsion polymers can be engineered for good adhesion and film integrity. They are often selected for applications requiring robust mechanical properties in the as-cast film. PVAc offers strong adhesion and film formation. Certain formulations of PU binders can provide flexibility and adhesion while decomposing under controlled conditions.

### Conventional Thought of Removing Binder

The binder should not only facilitate uniform film casting but also allow for efficient lithiation of aluminum during the alloy formation. In many cases, the binder is required to decompose or be removed during post-processing (such as sintering or lithiation) to ensure that no residual carbon or impurities adversely affect the electrochemical performance of the Li—Al alloy anode. The conventional thought is that any residue left can impact the diffusion of lithium into the aluminum matrix, affecting phase formation and electrode performance, and thus a binder that burns off cleanly under controlled thermal conditions is usually considered advantageous.

### Surprising Effects of Keeping Binder

However, it is surprisingly found that keeping the binder in the Al-containing film for making the anode layer in the method provided herein has unexpected benefits. The binder plays a crucial role in determining the uniformity, surface smoothness, and loading density of the Al-containing film, which is essential for fabricating a high-performance Al—Li alloy anode for all-solid-state batteries. The selection and optimization of the binder directly influence how well the aluminum powder is dispersed within the slurry, how smoothly the film spreads during casting, and how evenly it dries, all of which are critical for ensuring a dense and uniform Al film suitable for subsequent lithiation.

### Enhancing Film Evenness and Surface Smoothness

One of the primary functions of the binder in wet casting is to facilitate the formation of a continuous and defect-free film. A well-formulated binder system ensures that the aluminum particles remain homogeneously distributed throughout the slurry, preventing aggregation or sedimentation that could lead to rough or uneven surfaces. During the drying phase, the binder helps to control solvent evaporation rates, reducing the formation of surface defects such as cracks, voids, or bumps. A binder with the appropriate rheological properties, such as PVA or CMC, acts as a stabilizer, preventing uneven shrinkage as the film dries. By maintaining a uniform viscosity and providing consistent adhesion between particles, the binder minimizes localized density variations that could cause topographical irregularities on the film's surface. Additionally, the binder contributes to the flowability of the slurry during casting. Binders that provide shear-thinning behavior, such as methylcellulose or PAA, allow the slurry to spread smoothly under shear force while maintaining stability once the film is deposited. This results in an even, smooth film that ensures consistent lithium diffusion and alloying in the subsequent lithiation process.

### Controlling Al Loading Density

The loading density of aluminum in the Al-containing film is another critical factor that influences the performance of the Al—Li alloy anode. A binder system with well-adjusted viscosity and dispersion properties enables precise control over the solid content in the slurry, which in turn determines the final aluminum mass per unit area of the film. If the binder concentration is too low, the aluminum particles may settle or redistribute unevenly, leading to non-uniform film thickness and inconsistent lithiation behavior. Conversely, an excessively high binder content can introduce excessive porosity or interfere with sintering, reducing the overall density of the aluminum film.

### Optimizing Formulation

By carefully selecting binders with tailored molecular weights and functional groups, the formulation can be optimized to balance film flexibility, particle adhesion, and loading control. Water-soluble binders like PVA or CMC allow for fine-tuning of viscosity, ensuring that the slurry maintains the right balance between ease of spreading and structural integrity.

### Impact on the Al—Li Alloy Formation

A well-structured Al film with a smooth surface and controlled density significantly enhances the formation of a uniform Al—Li alloy anode. If the aluminum film is too porous or uneven, lithium penetration during alloying may be inconsistent, leading to localized phase variations and non-uniform electrochemical performance. A denser, evenly packed aluminum film ensures that lithium diffusion occurs in a controlled and predictable manner, allowing for the formation of a stable Li—Al alloy with minimal resistance and optimal mechanical properties.

### Effects of Binder

By promoting even dispersion, controlling drying behavior, and fine-tuning the slurry viscosity, the binder ensures that the final film has a smooth surface and optimal loading density. This, in turn, enhances lithium alloying kinetics, improves cycling stability, and contributes to the overall electrochemical performance of the solid-state battery. Therefore, careful selection and optimization of the binder system are essential for achieving a high-performance A-Li alloy anode. Furthermore, the binder system may be optimized with additives or mixed with dispersants that enhance the homogeneity of the aluminum slurry. The casting process parameters (e.g., drying temperature and time) and the subsequent post-casting treatments (e.g., sintering in a reducing atmosphere) should be aligned with the thermal decomposition characteristics of the chosen binder.

### Solvent

The solvent ensures proper dispersion of Al powder, binder solubility, and smooth film formation. The solvent must be carefully selected based on its evaporation rate, compatibility with binders, and ability to produce a uniform and defect-free film.

### Water-Based Solvents

Water-based solvents, such as deionized water, are environmentally friendly and non-toxic, making them a common choice when used with water-soluble binders like polyvinyl alcohol (PVA) or carboxymethyl cellulose (CMC). Ethanol-water and isopropanol-water mixtures are sometimes used to reduce surface tension and improve drying behavior while maintaining good dispersion of solid components.

### Alcohol-Based Solvents

Alcohol-based solvents, including ethanol, isopropanol, and methanol, provide fast evaporation and good dispersibility. Ethanol and isopropanol are widely used due to their relatively low toxicity and effective drying characteristics, while methanol is less common due to its higher toxicity. Butanol, with a slower drying rate, can help control film formation and reduce defects caused by rapid solvent evaporation.

### Ketone-Based Solvents

Ketone-based solvents such as acetone, methyl ethyl ketone (MEK), and cyclohexanone offer good dissolving power for many binders. Acetone evaporates very quickly, which may lead to film defects if not controlled properly, while MEK and cyclohexanone provide a more moderate evaporation rate, allowing for improved film uniformity.

### Ester-Based Solvents

Ester-based solvents like ethyl acetate and butyl acetate are often used in coatings due to their low toxicity and good film-forming properties. Ethyl acetate evaporates quickly, whereas butyl acetate provides slower evaporation, reducing the risk of film shrinkage and cracking. Propylene glycol monomethyl ether acetate (PGMEA) is another widely used ester solvent, known for producing smooth, uniform films.

### Glycol Ethers

Glycol ethers, including ethylene glycol, propylene glycol, diethylene glycol monomethyl ether (DEGME), and triethylene glycol monomethyl ether (TEGME), offer high boiling points and slow evaporation rates, which can be beneficial for maintaining uniform film thickness and preventing premature drying. These solvents help improve dispersion and allow for high solid-content formulations.

### Aromatic and Hydrocarbon Solvents

Aromatic and hydrocarbon solvents such as toluene, xylene, n-hexane, and n-heptane are sometimes used for their strong dissolving power. Toluene and xylene are effective in dissolving many polymer binders, but their toxicity limits their use. Hexane and heptane, being non-polar, are useful for dispersing hydrophobic components, though they require careful handling due to their flammability.

### Chlorinated Solvents

Chlorinated solvents like dichloromethane (DCM) and chloroform have strong solvency power but are rarely used due to their high toxicity and environmental concerns. However, they can be considered for specialized applications requiring aggressive solvent action.

### Ionic Liquid Solvents and Supercritical Fluids

Ionic liquid solvents such as 1-butyl-3-methylimidazolium tetrafluoroborate (BMIM-BF4) and 1-ethyl-3-methylimidazolium acetate (EMIM-Ac) are explored for their non-volatile nature and high thermal stability. While expensive, these solvents provide unique benefits in specialized formulations. Additionally, supercritical fluids like supercritical carbon dioxide (CO₂) are being investigated for solvent-free deposition methods in ultra-thin film applications.

### Optimal Solvent Selection

For making an Al film to be used in a Li—Al alloy anode, water-based solvents like deionized water or ethanol-water mixtures are often preferred due to their low toxicity and environmental safety. However, organic solvents such as ethanol, isopropanol, acetone, or MEK may be chosen when better drying control and compatibility with specific binders are required. The optimal solvent selection depends on balancing evaporation rate, film uniformity, and process safety to ensure high-quality electrode fabrication.

Dispersants and/or Surfactants

The dispersants and/or surfactants stabilize aluminum (Al) powder in the solvent system. These additives help prevent particle agglomeration, improve dispersion uniformity, and ensure smooth film formation. The choice depends on the solvent, binder system, and desired film characteristics, including loading density and surface smoothness.

### Polymeric Dispersants

Polymeric dispersants such as polyvinylpyrrolidone (PVP), polyethylene glycol (PEG), and polyacrylic acid (PAA) are widely used due to their ability to adsorb onto particle surfaces, providing steric stabilization. PVP is particularly effective in both aqueous and organic solvents, ensuring well-dispersed suspensions. PEG offers excellent solubility and compatibility with various solvent systems, while PAA is often used in water-based formulations to enhance dispersion stability.

### Anionic Dispersants

Anionic dispersants, including ammonium polyacrylate, sodium dodecyl sulfate (SDS), and sodium polyphosphate, improve electrostatic repulsion between Al particles, preventing agglomeration. Ammonium polyacrylate is commonly used in aqueous systems, as it provides strong charge stabilization. SDS is a well-known surfactant that enhances dispersion by reducing surface tension, though it may introduce unwanted foaming. Sodium polyphosphate acts as a dispersing agent by breaking down particle clusters and improving suspension homogeneity.

### Cationic Dispersants

Cationic dispersants such as cetyltrimethylammonium bromide (CTAB) and polyethyleneimine (PEI) function by adsorbing onto negatively charged surfaces, altering the zeta potential to stabilize dispersions. CTAB is effective in organic systems, while PEI provides strong binding to metal particles, promoting better film uniformity. However, their use must be carefully controlled, as excessive cationic surfactants can lead to particle flocculation instead of dispersion.

### Nonionic Surfactants

Nonionic surfactants, including Triton X-100, Tween 80, and Pluronic block copolymers, help reduce surface tension and stabilize suspensions without introducing electrostatic interactions. Triton X-100 is widely used in organic and aqueous systems to enhance wetting and prevent aggregation. Tween 80, being biocompatible, is often chosen for environmentally friendly formulations. Pluronic surfactants, composed of polyethylene oxide (PEO) and polypropylene oxide (PPO), provide both steric stabilization and viscosity control in dispersions.

### Small-Molecule Dispersants

Small-molecule dispersants such as citric acid, oleic acid, and stearic acid improve particle dispersion by modifying surface interactions. Citric acid is particularly effective in aqueous systems, as it binds to metal surfaces and enhances electrostatic repulsion. Oleic acid and stearic acid, being long-chain fatty acids, are more suitable for nonpolar solvent systems, providing steric hindrance to prevent particle agglomeration.

### Inorganic Dispersants

Inorganic dispersants, including phosphoric acid, silane coupling agents, and alumina-coated additives, are sometimes used to modify particle surfaces for improved dispersion. Phosphoric acid enhances charge stabilization, particularly in acidic aqueous environments. Silane coupling agents improve adhesion between Al particles and polymer binders, promoting film integrity. Alumina-coated additives help control surface interactions, reducing excessive particle settling during processing.

### Optimal Dispersant or Surfactant Choice

The optimal dispersant or surfactant choice depends on the solvent system, binder compatibility, and desired film properties. In water-based systems, polyacrylic acid, ammonium polyacrylate, and citric acid are commonly used due to their strong dispersing effects. In organic solvents, polyvinylpyrrolidone, oleic acid, and Triton X-100 offer effective dispersion while maintaining film smoothness. Polyethylene glycol (PEG) or sodium polyacrylate can be incorporated to further improve particle distribution, ensuring a denser and more homogenous aluminum film. The careful selection and optimization of these additives ensure uniform particle distribution, prevent aggregation, and contribute to the overall performance of the solid-state battery electrode.

### Al Powder Content

In the slurry, a high solids loading is typically targeted to achieve a dense, uniform film while retaining workable rheology. The aluminum powder usually constitutes about 60 to about 80 percent by weight of the total weight of the slurry. The slurry may contain the Al powder in an amount of at or about 60, 61, 62, 63, 64, 65, 66, 67, 68, 69, 70, 71, 72, 73, 74, 75, 76, 77, 78, 79, or 80 wt %. In embodiments, the weight percentage of the Al powder in the slurry may be within a range formed by selecting any two numbers provided herein, such as from about 60 to about 70, from about 65 to about 75, from about 70 to about 80, from about 66 to about 77 wt %, etc. This high percentage helps ensure that the final film has the necessary density and conductivity required for efficient alloy formation. The aluminum powder may constitute less than about 60 or more than about 80 percent by weight of the total weight of the slurry in other embodiments, such as at or about 1, 5, 10, 15, 20, 25, 30, 35, 40, 45, 50, 55, 85, 90, or 95 wt %. In embodiments, the weight percentage of the Al powder in the slurry may be within a range formed by selecting any two numbers provided herein, such as from about 20 to about 30, from about 45 to about 55, from about 85 to about 80, from about 85 to about 90, from about 40 to about 70, from about 75 to about 85 wt %, etc.

### Binder Content

The binder, which is critical for providing mechanical cohesion and aiding film formation, is usually incorporated at a level of about 0.1 to about 10 percent by weight of the entire slurry. The slurry may contain the binder in an amount of at or about 0.1, 0.2, 0.3, 0.4, 0.5, 0.6, 0.7, 0.8, 0.9, 1, 2, 3, 4, 5, 6, 7, 8, 9, or 10 wt %. In embodiments, the weight percentage of the binder in the slurry may be within a range formed by selecting any two numbers provided herein, such as from about 3 to about 5, from about 4 to about 8, from about 5 to about 7, from about 6 to about 10 wt %, etc. The slurry may also contain the binder in an amount less than about 0.1 or greater than 10 wt %, for example, at or about 0.01, 0.02, 0.03, 0.04, 0.05, 0.06, 0.07, 0.08, 0.09, 11, 12, 13, 14, 15, 16, 17, 18, 19, 20 wt %, etc. In embodiments, the weight percentage of the binder in the slurry may be within a range formed by selecting any two numbers provided herein, such as from about 0.03 to about 0.05, from about 0.04 to about 0.08, from about 0.05 to about 0.07, from about 1 to about 20, from about 5 to about 15, from about 12 to about 18 wt %, etc. The exact amount depends on the binder's molecular characteristics and its efficiency in promoting particle adhesion; a lower percentage may be sufficient with highly effective binders, whereas formulations requiring extra film strength might use amounts at the upper end of that range.

### Solvent Content

The solvent, essential for dispersing both the aluminum powder and binder, typically makes up the balance of the composition. In practice, the solvent content might range from abut 10 to about 40 percent by weight of the entire slurry, though many processes aim for a total solids loading (aluminum plus binder and any other additives) of 60 to 80 percent. The slurry may contain the solvent in an amount of at or about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt %. The slurry may also contain the solvent in an amount less than about 10 or greater than about 40 wt %, such as at or about 1, 2, 3, 4, 5, 6, 7, 8, 9, 41, 42, 43, 44, 45, 46, 47, 48, 49, 50 wt %, etc. In embodiments, the weight percentage of the binder in the slurry may be within a range formed by selecting any two numbers provided herein, such as from about 10 to about 25, from about 15 to about 30, from about 30 to about 35, from about 30 to about 40, from about 5 to about 9, from about 40 to about 45, from about 45 to about 50 wt %, etc. This parameter is often adjusted based on the desired viscosity and drying characteristics, with the goal of achieving a smooth, even film without defects or excessive porosity.

### Dispersants or Surfactants Content

Optional dispersants or surfactants, which are added to improve particle dispersion and stabilize the suspension, are generally used in much lower amounts. Typically, these additives are incorporated at about 0.5 to about 2 percent by weight relative to the aluminum powder, such as at or about 0.5, 0.6, 0.7, 0.8, 0.9, 1, 1.1, 1.2, 1.3, 1.4, 1.5, 1.6, 1.7, 1.8, 1.9, or 2 wt % relative to the weight of the Al powder. The weight percentage of these additives relative to the total weight of the Al powder may be less than 0.5 or greater than 2 wt %, such as at or about 0.01, 0.05, 0.1, 0.2, 0.3, 0.4, 2.1, 2.2, 2.3, 2.4, 2.5, 2.6, 2.7, 2.8, 2.9, 3, 4, 5 wt %, etc. In embodiments, the weight percentage of these additives relative to the total weight of the Al powder may be within a range formed by selecting any two numbers provided herein, such as from about 0.5 to about 1.5, from about 1 to about 1.8, from about 0.6 to about 1.2, from about 1.5 to about 2, from about 0.01 to about 0.1, from about 0.2 to about 0.3, from about 2.1 to about 2.4, from about 2.5 to about 3, from about 4 to about 5 wt %, etc. Even small variations in this percentage can significantly affect the homogeneity of the slurry and, consequently, the quality of the final film.

### Low-Shear Mixing

When preparing the slurry, proper mixing ensures uniform dispersion of the aluminum powder, binder, and any additives such as dispersants or surfactants. One common approach is to begin with a low-shear mixing process. In this initial stage, the binder is dissolved in the chosen solvent to create a homogeneous solution. This step can be performed using a magnetic stirrer or a mechanical stirrer set to a moderate speed, ensuring that the binder fully dissolves without causing significant air entrapment. Once the binder solution is ready, the aluminum powder is gradually introduced into the mixture. It is important to add the powder slowly while continuously stirring to prevent clumping and to allow the binder solution to coat each particle evenly.

### High-Shear Mixing

After the initial blending, the slurry often benefits from high-shear mixing. High-shear mixers or homogenizers can be used to further disperse the aluminum particles and break up any agglomerates that may have formed during the initial mixing. This process involves subjecting the slurry to intense mechanical forces, which can help reduce the particle size distribution and improve the overall homogeneity of the mixture. In some cases, the process is assisted by ultrasonication, where ultrasonic waves are applied to the slurry to promote deagglomeration and achieve an even finer dispersion. Ultrasonication is particularly effective in breaking down larger clusters of particles, ensuring that the aluminum is uniformly distributed throughout the binder solution.

### Temperature Control

In addition to mechanical mixing and ultrasonication, maintaining proper temperature control during the mixing process can also be beneficial. Slight warming of the slurry can lower the viscosity of the binder solution, facilitating better mixing and dispersion of the aluminum particles. However, temperature must be controlled carefully to avoid premature solvent evaporation or degradation of the binder. The process may also include a period of recirculation or rest after high-shear mixing, allowing any entrained air bubbles to escape and ensuring a more stable, homogeneous slurry.

### Controlled Mixing

Overall, the combination of low-shear initial mixing, high-shear homogenization, and, if necessary, ultrasonication and controlled temperature conditions, results in a slurry with a uniform distribution of components. This careful control of the mixing process produces a high-quality aluminum film with the desired mechanical and electrochemical properties for use in fabricating Li—Al alloy anodes in all-solid-state batteries.

### Thickness of Al-Containing Film

The Al-containing film may have a thickness from about 0.1 to about 100 μm, such as at or about 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, 50, 55, 60, 65, 70, 75, 80, 85, 90, 95, or 100 μm. The Al-containing film may have a thickness less than 0.1 or greater than 100 μm, such as at or about 0.01, 0.02, 0.03, 0.04, 0.05, 0.06, 0.07, 0.08, 0.09, 101, 102, 103, 104, 105, 106, 107, 108, 109, 110, 115, 120, 125, 130, 140, 150, 160, 170, 180, 190, 200 μm, etc. In embodiments, the thickness of the Li foil may be within a range formed by any two number selected from the numbers provided herein, such as from about 0.1 to about 1, from about 0.5 to about 2, from about 1 to about 5, from about 5 to about 10, from about 20 to about 60, from about 30 to about 50, from about 50 to about 80, from about 40 to about 90 μm, from about 0.01 to about 0.05 μm, from about 0.05 to about 0.09 μm, from about 105 to about 110 μm, from about 0.05 to about 0.5 μm, from about 50 to about 150 μm, from about 150 to about 200 μm, etc.

### Forming Alloy

### Li Foil

A Li foil is provided on top of a current collector. The Li foil may have a thickness from about 0.1 to about 100 μm, such as at or about 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, 50, 55, 60, 65, 70, 75, 80, 85, 90, 95, or 100 μm. The Li foil may have a thickness less than 0.1 or greater than 100 μm, such as at or about 0.01, 0.02, 0.03, 0.04, 0.05, 0.06, 0.07, 0.08, 0.09, 101, 102, 103, 104, 105, 106, 107, 108, 109, 110, 115, 120, 125, 130, 140, 150, 160, 170, 180, 190, 200 μm, etc. In embodiments, the thickness of the Li foil may be within a range formed by any two number selected from the numbers provided herein, such as from about 0.1 to about 1, from about 0.5 to about 2, from about 1 to about 5, from about 5 to about 10 μm, from about 20 to about 60, from about 30 to about 50, from about 50 to about 80, from about 40 to about 90 μm, from about 0.01 to about 0.05 μm, from about 0.05 to about 0.09 μm, from about 105 to about 110 μm, from about 0.05 to about 0.5 μm, from about 50 to about 150 μm, from about 150 to about 200 μm, etc. The current collector is described in detail in the “Other Aspect” section below.

Overlaying Al-Containing Film with Li Foil

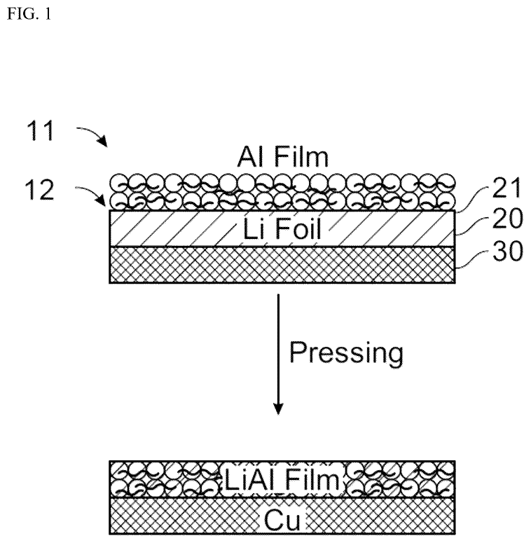

The Al-containing film is overlayed with the Li foil. As illustrated in FIG. 1, the Al-containing film 11 has a surface 12, and the Li foil 20 has a surface 21. The Li foil 20 may be placed on top of a conductive substrate or current collector 30, such as copper, and the Al-containing film 11 is overlayed on top of the Li foil 20. As a result, the surface 11 of the Al-containing film 11 contacts the surface 21 of the Li foil 20.

### Sandwich Configuration

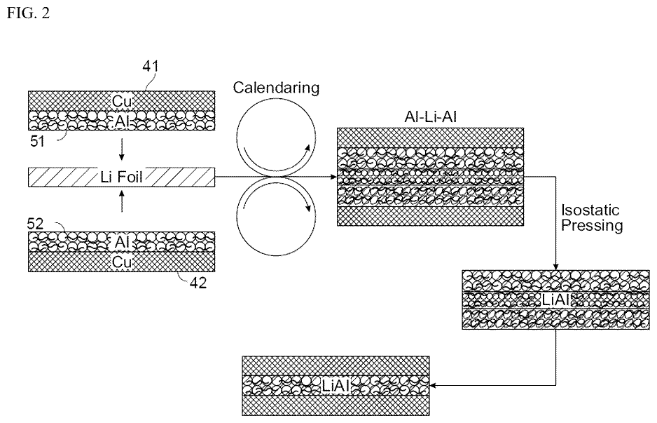

Alternatively, the Li foil may be overlaid between two Al-containing films in a “sandwich” configuration, as illustrated in FIG. 2. In this configuration, a first Al-containing film 51 is overlaid with a first conductive substrate 41, and a second Al-containing film 52 is overlaid with a second conductive substrate 42. The Li foil is overlaid between the first Al-containing film 51 and the second Al-containing film 52.

### Al Loading

Al loading refers to the amount of aluminum incorporated into the electrode. This is typically quantified in terms of mass per unit area (e.g., mg/cm²) or as a percentage of the total electrode composition. The Al content is a critical parameter that influences the electrode's electrochemical performance, mechanical properties, and compatibility with the solid electrolyte. In some embodiments, the Al loading may be within the range from about 5 to about 7.6 mg/cm², such as at or about 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, or 7.6 mg/cm². This range of the Al loading could result in an electrode with an areal capacity within a range from about 5 to about 7.5 mAh/cm². The Al loading may also be less about 5 or greater than about 7.6 mg/cm², such as at or about 1, 1.5, 2, 2.5, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 7.7, 7.8, 7.9, 8, 8.1, 8.2, 8.3, 8.4, or 8.5 mg/cm², etc. In embodiments, the Al loading may be within a range formed by selecting any two numbers provided herein, such as from about 4.5 to about 5, from about 5 to about 5.5, from about 6 to about 7, from about 5.5 to about 6.5, from about 6.8 to about 8.5 mg/cm², etc.

### Lithium Insertion and Extraction

One of the primary roles of aluminum in the Li—Al alloy electrode is to act as an active material that undergoes reversible alloying and dealloying reactions with lithium during charge and discharge cycles. The formation of lithium-aluminum alloys, such as LiAl and Li_xAl, enables lithium storage, contributing to the battery's capacity. However, the amount of aluminum present must be carefully controlled to ensure efficient lithium insertion and extraction without compromising the electrode's stability.

### Electrode Electronic and Ionic Conductivity

The electronic and ionic conductivity of the electrode also depends on Al loading. While increasing aluminum content enhances lithium storage capacity, excessive Al loading may reduce the electrode's electrical conductivity, potentially leading to sluggish charge transport. Additionally, higher Al content can cause significant volume expansion during lithiation, which may induce mechanical stress and lead to structural degradation over multiple cycles.

### Optimizing Al Loading

Optimizing Al loading is particularly important for solid-state batteries, where electrode-electrolyte interfaces play a crucial role in battery performance. The electrode must maintain intimate contact with the solid electrolyte to ensure efficient ion transport. If Al loading is too high, electrode expansion may lead to interface delamination, increasing resistance and reducing the overall efficiency of the battery. Therefore, fine-tuning the Al content and electrode thickness is essential to balance capacity, conductivity, and mechanical stability.

### Pressing Pressure

The Al-containing film(s) and the Li foil may be pressed under a pressure from about 100 to about 500 MPa, such as at or about 100, 105, 110, 115, 120, 125, 130, 135, 140, 145, 150, 155, 160, 165, 170, 175, 180, 185, 190, 195, 200, 205, 210, 211, 220, 225, 230, 235, 240, 245, 250, 255, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500 MPa. The Al-containing film(s) and the Li foil may also be pressed under a pressure less than 100 or greater than 500 MPa, such as at or about 50, 60, 70, 80, 90, 500, 550, 600, 650, 700, 750 MPa, etc. In embodiments, the pressure may be within a range formed by any two number selected from the numbers provided herein, such as from about 100 to about 200, from about 150 to about 200, from about 200 to about 350, from about 125 to about 400, from about 300 to about 500 MPa, from about 50 to about 100, from about 70 to about 120, from about 450 to about 550, from about 500 to about 750, from about 350 to about 550, etc.

### Pressing Temperature

The Al-containing film(s) and the Li foil may be pressed at a temperature from about 20 to about 150° C., such as at or about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, or 150° C. The Al-containing film(s) and the Li foil may be pressed at a temperature below about 20 or greater than 150° C., such as at or about 10, 11, 12, 13, 14, 15, 16, 17, 18, 19, 151, 152, 153, 154, 155, 156, 157, 158, 159, 160, 165, 170, 175, 180, 185, 190, 200, 210, 220, 230, 240, 250, 260, 270, 280, 290, 300° C., etc. In embodiments, the temperature may be within a range formed by any two number selected from the numbers provided herein, such as from about 20 to about 40, from about 50 to about 100, from about 100 to about 120, from about 60 to about 140, from about 70 to about 90, from about 15 to about 20, from about 150 to about 200, from about 125 to about 175, from about 100 to about 300° C., etc.

### Pressing Duration

The Al-containing film(s) and the Li foil may be pressed for a duration of from about 5 to about 60 minutes, such as at or about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 minutes. The Al-containing film(s) and the Li foil may be pressed for a duration less than 5 or greater than 60 minutes, such as at or about 1, 2, 3, 4, 61, 62, 63, 64, 65, 66, 67, 68, 69, 70, 75, 80, 85, 90, 95, 100, 110, 120, 130, 140, 150 minutes, etc. In embodiments, the duration may be within a range formed by any two number selected from the numbers provided herein, such as from about 5 to about 40, from about 50 to about 60, from about 10 to about 20, from about 20 to about 40, from about 30 to about 60 minutes, from about 1 to about 10 minutes, from about 40 to about 60 minutes, from about 30 to about 60 minutes, from about 60 to about 120 minutes, etc.

### Calendaring

As illustrated in FIG. 2, the pressing of the Al-containing film(s) and the Li foil may be realized by calendaring. Calendaring is a process in which a material—often in sheet or roll form—is passed through a series of rollers to compress, shape, and improve its overall properties. In the context of battery manufacturing, calendaring is used to compress electrode coatings on current collectors, such as forming the LiAl alloy anode on the Cu current collector in the method provided herein, thereby reducing porosity and enhancing particle contact within the electrode. This compression increases the electrode's density, which is critical for improving electrical conductivity and energy density. By precisely controlling pressure, and sometimes temperature, calendaring helps achieve a uniform thickness and microstructure across the electrode, ensuring consistent performance.

### Isostatic Pressing

In the calendaring process, the pressing is isostatic pressing that applies uniform pressure in all directions to the Al-containing film(s) and the Li foil to consolidate them into a dense, solid LiAl alloy anode. This technique can be performed at room temperature, known as cold isostatic pressing (CIP), or at elevated temperatures, known as hot isostatic pressing (HIP), depending on the material and desired properties. In both cases, the process minimizes defects and achieves a uniform density, which is critical for improving mechanical strength and overall performance in the final product.

### Alloying Process Overview

The pressing of the Al-containing film and the Li foil together initiates mechanical deformation at the interface, creating defects that serve as diffusion channels. Lithium atoms then migrate into the aluminum lattice via interstitial sites and defect pathways, leading to the nucleation and growth of an intermetallic Li—Al phase. This atomic interdiffusion process transforms the interface into a homogeneous alloy layer, which is essential for achieving the desired electrochemical properties in all-solid-state battery electrodes.

### Initiating Alloy Formation

Specifically, when the Al-containing film and the Li foil are pressed together, the process initiates a series of atomic-scale movements that ultimately result in interdiffusion and the formation of a new intermetallic phase. Initially, both the Al-containing film and the Li foil consist of their respective pure metal crystal lattices. When pressed together, the applied mechanical force forces the surfaces into extremely close contact, overcoming surface roughness and inducing local deformations. This intimate contact is accompanied by the generation of lattice distortions, dislocations, and vacancies at the interface. These defects serve as fast diffusion pathways by lowering the energy barrier for atomic migration, setting the stage for alloy formation.

### Li Diffusion

At the atomic level, lithium atoms—being smaller and inherently more mobile than aluminum atoms—begin to diffuse from the Li foil into the Al-containing film. This diffusion is driven by the concentration gradient present at the interface and is enhanced by the increased chemical potential resulting from the applied pressure. Under these conditions, Li atoms leave their original lattice positions in the Li foil and migrate into the aluminum lattice through interstitial sites and along defect pathways created by the pressing process. They may also substitute for aluminum atoms in the lattice, gradually altering the local structure of the Al film.

### Alloying Reaction

As lithium atoms accumulate within the aluminum matrix, they interact with the surrounding aluminum atoms, leading to the nucleation of intermetallic compounds. This initial nucleation is thermodynamically favorable because the formation of a Li—Al alloy reduces the overall free energy of the system compared to the separated pure metals under high-pressure conditions. With continued diffusion, the intermetallic phase grows outward from the interface. The growing alloy layer gradually adopts a distinct crystal structure—often characteristic of phases such as LiAl—resulting in a transition zone that evolves from a sharp interface into a more uniform alloy region.

### Reaching Equilibrium

While lithium diffusion dominates due to its high mobility, some aluminum atoms may also diffuse toward the lithium-rich side of the interface, though to a lesser extent because of their larger atomic size and lower diffusivity. Over time, as the diffusion process progresses and the concentration gradients diminish, the system approaches an equilibrium state where the newly formed Li—Al alloy exhibits a relatively uniform composition and structure. This homogeneous intermetallic layer is crucial for the performance of the electrode, as it promotes consistent electrochemical behavior and mechanical stability.

### ANODFAnode

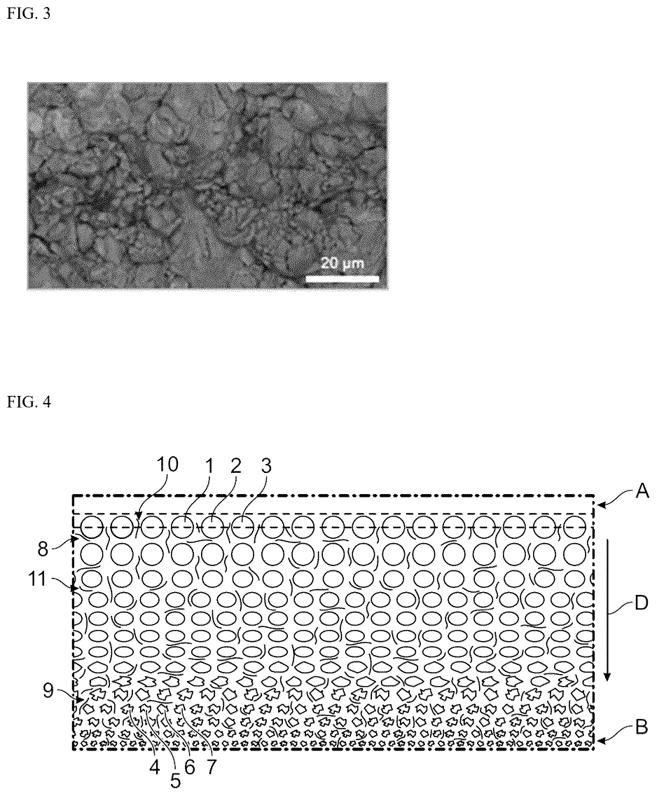

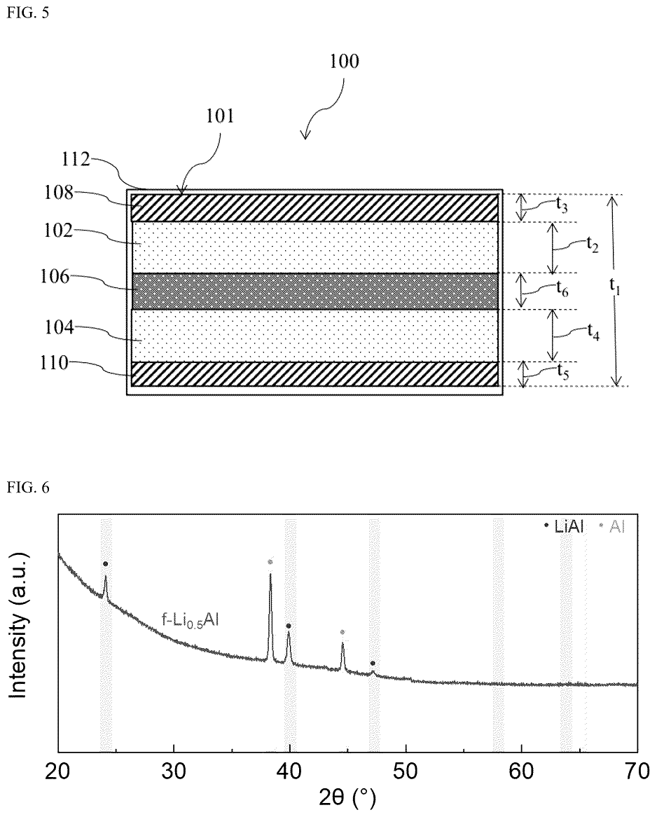

One aspect of the present disclosure is an anode, as illustrated in FIGS. 1 and 2, made by the method provided herein. The anode has a current collector and an anode active material layer. Details of the current collector are provided in the “OTHER ASPECTS” section below. As shown in FIGS. 3 and 4, the anode active material layer includes a polymer binder and particles containing lithium-aluminum alloy (LiAl) (hereinafter “LiAl-containing particles”). The anode active material layer has a first surface A and a second surface B. There may be Al particles on the first surface A and Li metal on the second surface B. As illustrated in FIG. 4, particles closer to the first surface A, such as particles 1-3, are less lithiated than those closer to the second surface B, such as particles 4-7 and have a generally round shape. In contrast, particles closer to the second surface B, such as particles 4-7, are more lithiated than those closer to the first surface A, such as particles 1-3, and have less round shapes, and are generally smaller than the less lithiated particles. Additionally, molecules of the polymer binder, such as 8-11, are distributed generally throughout the anode. It is understood that the binder molecules, such as 8-11, illustrated in FIG. 4 are merely example binder molecules, and there may be more binder molecules that are not illustrated in FIG. 4. A portion of at least part of the polymer molecules is interposed between two adjacent LiAl-containing particles within the anode active material layer, creating a mechanically robust and electrochemically active composite suitable for high-performance all-solid-state battery applications. FIG. 3 is a SEM image of a cross-section of an example LiAl alloy formed using the method provided herein, showing the gradient of the less lithiated region in light gray to the more lithiated region in dark gray and the unlithiated Li metal residue in black.

### Less Lithiated Region

At, around or close to the first surface A of the anode layer, the LiAl-containing particles are characterized by a lower lithium content, larger size, and a generally round shape. This region suggests that the lithiation process is either less advanced or has been deliberately moderated, resulting in particles that retain a more isotropic, spherical morphology.

### Li Content Gradient

Moving from the first surface A toward the second surface B, a distinct gradient in morphology within the anode active material layer is observed. Along the direction D from the first surface A to the second surface B within the anode active material layer, there is a general trend where the amount of lithium in these particles increases. The LiAl-containing particles located near the first surface A, such as particles 1-3, include a lower amount of lithium, whereas those positioned closer to the second surface B, such as particles 4-7, tend to contain more lithium. This suggests that lithium accumulates more significantly within the LiAl-containing particles as they are positioned closer to the second surface B. The progressive increase in the lithium content within the LiAl-containing particles indicates more extensive lithiation. The extent to which lithium increases along this direction could be influenced by factors such as lithium diffusion kinetics, electrochemical reactions, and material properties within the anode. While the overall trend shows an increase in the lithium content moving toward the second surface B, there might be localized variations in lithium distribution due to factors such as differences in particle structure, reaction dynamics, or potential inhomogeneities in lithium diffusion. However, despite these possible variations, the overarching pattern remains: LiAl-containing particles tend to store progressively more lithium as they are positioned deeper within the anode active material layer, closer to the second surface B.

### Particle Size Gradient

Concurrently, there is a decreasing trend in particle size as the LiAl-containing particles' position shifts deeper into the anode active material layer. The average diameter or volume of individual LiAl-containing particles is reduced as they are located closer to the second surface B. In other words, LiAl-containing particles near the first surface A, such as particles 1-3, are relatively larger, whereas those found deeper in the anode active material layer, near the second surface B, such as particles 4-7, tend to be smaller in size. This suggests that there is a gradual breakdown of LiAl-containing particles as they move toward the second surface. The decrease of particle sizes is likely due to processes such as particle fragmentation or dissolution-reprecipitation that accompany the enhanced incorporation of lithium. Although the overall trend shows a reduction in particle size toward the second surface B, there may be localized deviations due to material heterogeneity or processing conditions. However, despite these possible variations, the general pattern holds: LiAl-containing particles tend to be larger near the first surface A and progressively decrease in size as they approach the second surface B, following the direction D within the anode active material layer.

### Particle Shape Gradient

Along with the size reduction, the particle shape evolves from the initially generally round, oval or like forms to less round, even more irregular geometries with sharp edges. Along the direction D toward the second surface B, the LiAl-containing particles generally become less round in shape. This means that particles near the first surface A, such as particles 1-3, are typically more spherical or rounded or oval, whereas those located closer to the second surface B tend to have a more irregular, elongated, or angular shape. The phrase “less round” refers to a deviation from an ideal spherical, oval or smooth shape, indicating that the LiAl-containing particles closer to the second surface B are more distorted, rough, or uneven compared to those near the first surface A. Some particles, such as particles 4-7, closer to the second surface B may have irregular shapes, and some may have sharp edges. This transition suggests that the higher lithium concentration induces anisotropic structural changes in the particles, possibly resulting from differential growth rates along specific crystallographic orientations or from mechanical stresses introduced during lithiation. While the overall trend points to a reduction in roundness, there may be localized variations where some particles retain more of their rounded shape depending on their specific position or exposure to lithium or lithiation. However, despite these potential variations, the broader pattern remains: LiAl-containing particles become progressively less round as they move deeper into the anode active material layer, closer to the second surface B.

### “Generally”

In this context, the term “generally” is used to indicate an overall trend or pattern that applies to most of the material, even though there may be localized variations or exceptions. For example, when it is stated that the amounts of lithium in the LiAl-containing particles generally increase from one surface to the other, it means that while most particles follow this trend, there might be a few that do not exactly conform to it. Similarly, saying that the particle sizes generally become smaller or that their shapes change from generally round, oval or like to less round implies that these are the predominant behaviors observed across the bulk of the layer. The use of “generally” thus conveys that the described tendencies are typical and characteristic of the system as a whole, rather than representing absolute, uniform changes for every individual particle.

### Binder Distribution

Throughout the entire anode layer, the polymer binder forms a continuous network, enveloping the particles and ensuring strong adhesion and electrical contact throughout the layer. Molecules of the polymer binder are interspersed generally uniformly, and a portion of at least part of the molecules of the polymer binder is interposed between two adjacent LiAl-containing particles. The LiAl-containing particles may be at least partially in contact with the binder. This intimate association helps to maintain a cohesive composite structure, facilitates electron and ion transport between particles, and minimizes the formation of isolated or poorly connected regions. The binder not only provides mechanical support but also contributes to a more uniform distribution of the active material, thereby enhancing the overall electrode performance.

### Binder Network

The polymer binder in the anode layer is not merely an inert filler but an integral component that defines the composite's structural and functional integrity. Its distribution throughout the layer may be controlled so that it is present at almost every or every interface between at least some of the LiAl-containing particles, ensuring continuous electrical connectivity and mechanical cohesion. As the slurry is cast and the alloy/composite is formed, the binder molecules may infiltrate the interstitial spaces among the particles. This creates a network that holds the entire structure together, minimizes micro-cracking, and supports efficient ion transport across the electrode.

### Encapsulation

In regions near the first surface A of the anode active material layer, where the LiAl-containing particles are larger and exhibit a more rounded morphology with lower lithium content, the binder may form relatively thicker layers around each particle. This robust encapsulation helps to stabilize the larger particles, ensuring that they maintain good contact with one another despite their size. As a result, the binder provides a cushioning effect that absorbs mechanical stresses and mitigates the risk of delamination during electrode handling and operation.

### Interwoven Network

Moving toward the second surface B, where the particles are smaller, contain higher lithium content, and evolve into less round shapes, the binder may be distributed as a finer, more intimately interwoven network that penetrates the complex contours of the irregularly shaped particles. This fine distribution is essential for filling the increased interstitial volume created by the smaller particles and their sharp edges, ensuring that there are no isolated regions within the electrode. The binder's presence at these interfaces not only secures the particles together but also facilitates more uniform electrochemical reactions by maintaining consistent ionic and electronic pathways.

Continuity The overall continuity of the binder distribution may be achieved through the fabrication process. The slurry formulation, mixing, and/or casting conditions may be optimized to promote a continuous dispersion of the binder alongside the LiAl-containing particles. Even as the particle characteristics change along the gradient—from larger, more round or oval particles to smaller, less round ones—the binder adjusts to these variations, remaining in proximity or contact with the surfaces of the particles. This continuous, adaptive distribution of the binder is fundamental in maintaining the mechanical resilience of the anode layer, ensuring efficient lithiation/delithiation cycles, and ultimately enhancing the performance and longevity of the all-solid-state battery.

### Binder Dynamics

During the pressing and alloying process, the binder exhibits dynamic behavior for accommodating the evolving morphology of the LiAl-containing particles. Initially, when the anode is formed, the binder may be uniformly dispersed throughout the composite, surrounding the larger, more rounded LiAl-containing particles or interposing between two adjacent LiAl-containing particles near the first surface. As pressure is applied, the viscoelastic nature of the binder allows it to flow and conform to the surfaces of the particles, filling interstitial spaces and establishing strong mechanical and electrical connections.

### Binder Redistribution

As the alloying process progresses and lithium diffuses into the aluminum, the morphology of the LiAl-containing particles begins to evolve. In regions closer to the second surface, where lithiation is more extensive, the particles' sizes reduce, and their shapes evolve from generally smooth, round or oval forms to less round geometries. Under the influence of the applied pressure and the accompanying mechanical stresses, the binder continuously redistributes itself to maintain proximity or contact with the newly formed particle surfaces. Its molecular chains may stretch, reorient, and/or reflow into the smaller, more complex voids that develop as the particle shapes change, thereby minimizing any potential discontinuities in the anode active material layer.

### Dynamic Adjustment

This dynamic adjustment is driven by a combination of capillary forces, stress-induced flow, and the inherent tendency of the binder to minimize its surface energy. The binder adapts to the increasing particle irregularity by penetrating finer interstices and maintaining a continuous phase that envelops even the smallest, sharp-edged particles. In doing so, it not only ensures mechanical cohesion across the gradient but also preserves the electrical and ionic pathways essential for effective battery operation.

### Securing Morphology

Furthermore, any thermal or chemical effects during the pressing and alloying process, such as slight curing or cross-linking, can further stabilize the binder's reconfigured distribution. This “locking in” of the binder's arrangement helps to secure the gradient morphology, ensuring that the anode active material layer remains robust under subsequent cycling and operational stresses.

### Effects of Binder

In summary, the binder dynamically adjusts to the gradient in the anode active material layer by flowing, redistributing, and conforming to the evolving particle sizes and shapes, thereby ensuring a continuous, connected, mechanically resilient, and electrochemically efficient Li—Al alloy anode electrode for all-solid-state batteries.

### Li:Al Molar Ratio

The LiAl-containing particles may have a Li:Al molar ratio of from about 0.1 to about 5, such as at or about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5. The Li:Al molar ratio may also be less than about 0.1 or greater than about 5, such as at or about 0.01, 0.02, 0.03, 0.04, 0.05, 0.06, 0.07, 0.08, 0.09, 5.1, 5.2, 5.3, 5.4, 5.5, 5.6, 5.7, 5.8, 5.9, 6, 7, 8, 9, 10, etc. In embodiments, the molar ratio may be within a range formed by selecting any two numbers provided herein, such as from about 0.5 to about 1, from about 0.5 to about 1.5, from about 0.1 to about 2, from about 1 to about 5, from about 0.01 to about 0.05, from about 2.5 to about 7, from about 5 to about 10, from about 0.7 to about 1.2, etc.

### All Solid State Battery and Method of Making and Using Same

### All Solid State Battery

One aspect of the present disclosure is an all solid state battery comprising the anode provided herein, a cathode; and a solid electrolyte positioned between the cathode and the anode and configured to enable transport of lithium ions between the cathode and the anode. More details of the all solid state battery are provided in the “OTHER ASPECTS” section below.

### Method of Making Battery

Another aspect of the present disclosure is a method of making the all solid state battery provided herein. The cathode, the solid electrolyte, and the anode are pressed to form a compressed cell, and the compressed cell can be sealed in a pouch material to form a pouch.

### Process of Making Battery

Specifically, the cathode, the solid electrolyte, and the anode provided herein are carefully stacked in the desired sequence, ensuring proper alignment. This stacking is usually performed in an inert atmosphere to prevent contamination or oxidation, especially of sensitive materials like lithium metal. Once the layers of components are assembled, the entire stack may be placed into a die or mold that is designed to contain the materials and maintain alignment during compression. A plunger, typically part of a uniaxial hydraulic or mechanical press, may be used to apply a uniform, controlled pressure across the stack. The plunger moves downward steadily until the assembly reaches a predetermined pressure level. This pressing action forces the layers into intimate contact, reducing gaps, voids, or interfacial defects that could otherwise increase resistance and hinder ion transport. The applied pressure not only improves physical contact at the interfaces but can also help the layers conform to one another by slightly deforming or interlocking the surfaces. Maintaining this pressure for a set dwell time allows the materials to settle into a stable configuration with minimized interfacial resistance. In some manufacturing processes, this pressing step is followed by additional treatments, such as thermal annealing, to further enhance bonding between layers and to optimize the microstructure of the electrolyte or electrode materials.

### In Situ Process

Alternatively, an in-situ process may be adopted, and the alloy anode layer is made at the same time as the battery is made. In this in situ process, the sandwiched assembly of Cu substrate-Al-containing film-Li foil-Al-containing film-Cu substrate, as provided herein and illustrated in FIG. 2B, replaces the already-made anode in the process described above. When the plunger applies a uniform, controlled pressure to the stack, the intimate contact between the layers is enhanced. This pressing step serves several key functions. First, it minimizes any gaps or voids between the lithium foil and the Al-containing film, which is crucial for ensuring effective ionic and electronic pathways across the interface. Second, the applied pressure drives the diffusion of lithium atoms from the foil into the aluminum film. Under these conditions, the lithium gradually inter-diffuses with the aluminum, forming a Li—Al alloy directly at the interface. This in-situ alloy formation not only creates a more uniform anode layer but also improves the mechanical and electrochemical integration between the electrodes and the solid electrolyte.

### Optimization

The process may be further optimized by carefully controlling the dwell time and pressure during pressing, and in some cases, a subsequent thermal treatment may be applied. This thermal step can enhance the kinetics of lithium diffusion into the aluminum, leading to a more complete and uniform formation of the Li—Al alloy. By generating the anode in situ, the method circumvents potential issues associated with handling pre-alloyed electrodes, such as interfacial mismatches or inhomogeneities, and ultimately contributes to a solid-state battery with reduced internal resistance and improved cycling stability.

### Pressure

The applied pressure may be from about 100 to about 500 MPa, such as at or about 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500 MPa. The applied pressure may be less than about 100 or greater than 500 MPa, such as at or about 50, 60, 70, 80, 90, 550, 600, 650, 700, or 750 MPa, etc. In embodiments, the pressure may be within a range formed by selecting any two numbers provided herein, such as from about 100 to about 200, from about 125 to about 400, from about 200 to about 300, from about 250 to about 450, from about 50 to about 100, from about 80 to about 250, from about 450 to about 650, from about 500 to about 750 MPa, etc.

### Making Pouch Cell

A pouch cell may be made. The stack of cathode, solid electrolyte, and anode layers may be placed between two flexible current collector foils that will serve as the external electrical contacts for the cell. The entire assembly is then inserted into a pouch cell casing, which is usually made of an impermeable polymer film such as aluminum-laminated polyethylene terephthalate (PET) or a similar barrier material. A mechanical lamination or pressing step may be performed; and a plunger or hydraulic press may be used to apply a uniform pressure across the stack. After the layers are fully pressed together, the pouch cell is sealed using heat sealing or ultrasonic welding techniques. The sealing process must be performed under controlled conditions to ensure that no moisture or oxygen infiltrates the cell, as these can degrade sensitive materials such as lithium or the solid electrolyte. Finally, the assembled pouch cell may undergo a formation process in which it is subjected to initial charge-discharge cycles. This step helps to stabilize the interfaces and ensure that any minor imperfections in the contact or uniformity of the layers are mitigated through in situ electrochemical reactions. Post-formation, the pouch cell is typically subjected to a series of quality control tests, such as impedance spectroscopy and cycling tests, to verify that the internal interfaces are stable and that the cell meets performance specifications.

More details are provided in the “OTHER ASPECTS” section below.

### Other Aspects

The following provides other aspects of the present disclosure. The additional features, embodiments and examples discussed below will be applicable to various aspects of the invention discussed above. In case there is a conflict between information in the foregoing discussions and information in the following discussions, however, the information in the foregoing section should apply.

### Solid State Lithium Ion Batteries

A solid state battery can receive a charge and discharge an electrical load various times. A solid state battery includes electrodes, a cathode electrode and an anode electrode, and an electrolyte to allow lithium ions to travel between the electrodes. In contrast to conventional liquid electrolyte batteries, the solid state battery does not include any flowable liquids. Forming a circuit between the electrodes causes electricity to flow between the electrodes. During charging of the lithium ion rechargeable battery, lithium ions are emitted from the cathode electrode and are intercalated into an active material of the anode electrode. During discharging of the lithium ion rechargeable battery, lithium ions are emitted from the anode electrode and are intercalated into an active material of the cathode electrode. As lithium ions reciprocate between the electrodes, they transfer energy.

### Solid State Battery Configuration

The present disclosure provides a solid state battery 100 comprising a cathode electrode 102, an anode electrode 104, and a solid electrolyte layer 106 intermediate the cathode electrode 102 and the anode electrode 104. While listed as exemplary, the solid state battery 100 does not require all of these components. For example, in some configurations, such as in anodeless system, the anode electrode 104 may be omitted.

### Optional Additional Layers

The solid state battery 100 can optionally comprise an additional layer or layers, such as, for example, a separator layer, a protective layer, an inhibitor layer, a solid electrolyte interface layer, or a combination thereof.

### Protective Layer

For example, a protective layer may be incorporated between the electrodes 102 and 104 and the solid electrolyte layer 106. The protective layer may also serve to mitigate dendrite formation, particularly on the anode side, thereby improving the overall cycle life and safety of the battery.

### Protective Layer Materials

This protective layer may comprise materials such as lithium phosphate, lithium titanate, or lithium lanthanum zirconium oxide (LLZO), which can help prevent undesirable side reactions at the electrode-electrolyte interface.

### Separator Layer

A separator layer may also be included in some configurations of the solid state battery 100. These separator layers can provide additional mechanical support to the battery structure while still allowing for efficient ion transport. The separator layer may also be designed to have a gradient structure, with properties optimized for contact with both the cathode and anode materials.

### Separator Layer Materials

While traditional liquid electrolyte batteries often use porous polymer separators, solid state batteries may employ thin ceramic or glass-ceramic layers as separators. Materials such as LLZO, LATP (lithium aluminum titanium phosphate), or LAGP (lithium aluminum germanium phosphate) may be used for this purpose.

### Solid State Battery Cell

FIG. 1 illustrates a cell 101 of a solid state battery 100 according to an embodiment. The cell 101 includes a cathode electrode 102, an anode electrode 104, and a solid electrolyte layer 106 intermediate the cathode electrode 102 and the anode electrode 104. The cell 101 can optionally include an additional layer or layers, such as, for example, a separator layer, a protective layer, an inhibitor layer, a solid electrolyte interface layer, or a combination thereof.

### Cell Configuration

As illustrated in FIG. 1, the solid state battery 100 may include a single cell 101. In other examples, the solid state battery 100 can include multiple cells, such as, at least two cells, at least three cells, or at least four cells. Connecting the cells in series increases a voltage of the solid state battery 100 and connecting the cells in parallel increases an amp-hour capacity of the solid state battery 100.

### Dimensions of Cell

The cell 101 may have a width, w₁, a length, l₁, and a thickness, t₁.

### Thickness of Cell

A thickness, t₁, of the cell 101 can be at or about any number in a range of from about 100 μm to about 5000 μm, such as about 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400,410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1100, 1200, 1300, 1400, 1500, 1600, 1700, 1800, 1900, 2000, 3000, 4000, 5000 μm, or any other number between any two exemplary numbers listed herein. In some embodiments, the thickness, t₁, of the cell 101 may be within a range formed by selecting any two numbers within the range of from about 100 μm to about 5000 μm, e.g., between about 100 m and about 5,000 μm or about 100 μm and about 1,000 μm.

### Aspect Ratio of Width

The width, w₁, of the cell 101 may be substantially greater than the thickness, t₁, of the cell 101. In some embodiments, an aspect ratio of the width, w₁, to the thickness, t₁, may be at least 10, at least 20, at least 30, at least 40, at least 50, at least 60, at least 70, at least 80, at least 90, at least 100, at least 110, at least 120, at least 130, at least 140, at least 150, at least 160, at least 170, at least 180, at least 190, at least 200, at least 210, at least 220, at least 230, at least 240, at least 250, at least 260, at least 270, at least 280, at least 290, at least 300, at least 350, at least 400, at least 450, at least 500, at least 550, at least 600, at least 650, at least 700, at least 750, at least 800, at least 850, at least 900, at least 950, at least 1000, at least 2000, at least 3000, at least 4000, at least 5000, at least 6000, at least 7000, at least 8000, at least 9000, or at least 10000.

### Aspect Ratio of Length

The length, l₁, of the cell 101 may be substantially greater than the thickness, t1, of the cell 101. In some embodiments, an aspect ratio of the length, l₁, to the thickness, t₁, may be at least 10, at least 20, at least 30, at least 40, at least 50, at least 60, at least 70, at least 80, at least 90, at least 100, at least 110, at least 120, at least 130, at least 140, at least 150, at least 160, at least 170, at least 180, at least 190, at least 200, at least 210, at least 220, at least 230, at least 240, at least 250, at least 260, at least 270, at least 280, at least 290, at least 300, at least 350, at least 400, at least 450, at least 500, at least 550, at least 600, at least 650, at least 700, at least 750, at least 800, at least 850, at least 900, at least 950, at least 1000, at least 2000, at least 3000, at least 4000, at least 5000, at least 6000, at least 7000, at least 8000, at least 9000, or at least 10000.

### Cathode Electrode

The cathode electrode 102 is associated with one polarity (e.g., positive) of the solid state battery 100. The cathode electrode 102 is configured as a positive electrode during discharge of the solid state battery 100. The cathode electrode 102 is suitable for lithium ion diffusion between a current collector 108 and the solid electrolyte layer 106. The cathode electrode 102 is in electrical communication with the current collector 108.

### Cathode Electrode Positioning

In embodiments, the cathode electrode 102 is formed over and in direct contact with the current collector 108. In other embodiments, another functional layer may be interposed between the cathode electrode 102 and the current collector 108.

### Materials for Cathode Electrode

The cathode electrode 102 may be capable of reversible intercalation and deintercalation of lithium ions. For example, the cathode electrode 102 can comprise a cathode active material, a conductive carbon, a solid electrolyte material, a binder, the like, or combinations thereof. Optionally, the cathode electrode 102 may further comprise an additive, such as, for example, an oxidation stabilizing agent, a reduction stabilizing agent, a flame retardant, a heat stabilizer, an antifogging agent, a thickener, the like, or a combination thereof.

### Examples of Additives

Examples of these additives may include butylated hydroxyanisole (BHA) or butylated hydroxytoluene (BHT) as oxidation stabilizing agents, ascorbic acid or sodium sulfite as reduction stabilizing agents, aluminum hydroxide or magnesium hydroxide as flame retardants, phenolic compounds or phosphites as heat stabilizers, polyethylene glycol or silica nanoparticles as antifogging agents, and carboxymethyl cellulose (CMC) or xanthan gum as thickeners.

### Cathode Active Material

The cathode active material can include lithium cobalt oxide (LiCoO₂), lithium nickel oxide (LiNiO₂), Li[NiₐCo_{b}Mn_{c}M¹_{d}]O₂ (wherein M¹ is any one element elected from the group consisting of Al, Ga, In, or a combination thereof, 0.3≤a<1.0, 0≤b≤0.5, 0≤c≤0.5, 0≤d≤0.1, and a+b+c+d=1), Li(LiₑM²_{f-e-f}M³_{f′})O_{2-g}A_{g} (wherein 0≤e≤0.2, 0.6≤f≤1, 0≤f′≤0.2, 0≤g≤0.2, M² includes Mn and at least one element selected from the group consisting of Ni, Co, Fe, Cr, V, Cu, Zn and Ti, M³ is at least one element selected from the group consisting of Al, Mg and B, and A is at least one element selected from the group consisting of P, F, S and N), or those compounds substituted with one or more transition metals; lithium manganese oxides such as those represented by the chemical formula of Li^{1+h}Mn₂₋ₕO₄ (wherein 0≤h≤0.33), LiMnO₃, LiMn₂O₃, LiMnO₂, or the like; lithium copper oxide (Li₂CuO₂); vanadium oxides such as LiV₃O₈, V₂O₅ or Cu₂V₂O₇; Ni-site type lithium nickel oxides represented by the chemical formula of LiNi₁₋ᵢM⁴ᵢO₂ (wherein M⁴=Co, Mn, Al, Cu, Fe, Mg, B or Ga, and 0.01≤y≤0.3); lithium manganese composite oxides represented by the chemical formula of LiMn₂₋ⱼM⁵ⱼO₂ (wherein M⁵=Co, Ni, Fe, Cr, Zn, or Ta, and 0.01≤y≤0.1) or Li₂Mn₃M⁶O₈ (wherein M⁶=Fe, Co, Ni, Cu, or Zn); LiMn₂O₄ in which Li is partially substituted with an alkaline earth metal ion; disulfide compounds; LiFe₃O₄, Fe₂(MoO₄)₃; the like; or combinations thereof.

### Phosphate-Based Materials

In addition to the cathode active materials previously mentioned, the cathode electrode may include other types of materials. For example, lithium iron phosphate (LiFePO4) may be used as a cathode active material due to its excellent thermal stability and long cycle life. Other phosphate-based materials such as lithium manganese iron phosphate (LiMnxFe1-xPO4) or lithium cobalt phosphate (LiCoPO4) may also be suitable.

### Layered Oxide Materials

The cathode active material may also include layered oxide materials with various compositions, such as Li(Ni1-x-yCoxMny)O2 (NCM) or Li(Ni1-x-yCoxAly)O2 (NCA), where the ratios of Ni, Co, Mn, and Al can be adjusted to optimize performance characteristics. For instance, NCM materials with high nickel content, such as NCM811 (LiNi0.8Co0.1Mn0.1O2), may be used to achieve higher energy density. In some cases, the cathode active material may comprise spinel structures like LiNi0.5Mn1.5O4, which can offer high voltage operation. Alternatively, materials with tavorite structures, such as LiFeSO4F or LiVPO4F, may be employed for their potential for high energy density and good thermal stability.

### Composite or Blended Cathode Materials

Composite or blended cathode materials, combining two or more active materials, may also be used. For example, a blend of layered oxides and spinel materials might be employed to balance energy density and power capability. As another example, lithium iron phosphate may be blended with one or more of the cathode active materials described above. In some embodiments, the cathode active material may include surface-modified versions of the aforementioned compounds, where the surface modification aims to improve stability, conductivity, or other performance metrics.

### Emerging Classes of Materials

The cathode active material may also include emerging classes of materials such as disordered rock salt structures (e.g., Li3NbO4-based materials) or high-entropy oxides, which may offer desirable combinations of high capacity and structural stability. In some cases, the cathode active material may incorporate dopants or substitutional elements to further tune its electrochemical properties.

### Particulate Nature of Cathode Active Material

The cathode active material can be particle shaped. The cathode active material can have a particle size in a range of from about 1 nm to about 1000 μm, such as about any of 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 550 nm, 600 nm, 650 nm, 700 nm, 750 nm, 800 nm, 850 nm, 900 nm, 950 nm, 1000 nm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, 500 μm, 550 μm, 600 μm, 650 μm, 700 μm, 750 μm, 800 μm, 850 μm, 900 μm, 950 μm, 1,000 μm, or any other number between any two exemplary numbers listed herein. In embodiments, particle size of the cathode active material may be within a range formed by selecting any two numbers in the range of from about 1 nm to about 1000 μm, e.g., between about 10 nm and about 1,000 μm. Gaps between cathode active material particles in the cathode electrode 102 can be filled with the solid electrolyte material.

### Amount of Cathode Active Material in Cathode Electrode

The amount of the cathode active material in the solid state battery 100 affects the charge and discharge capacity of the solid state battery 100. In order to manufacture a high-capacity cathode electrode 102, a high level of cathode active material can be included in the cathode electrode 102. For example, the cathode electrode 102 includes at, about, or greater than 1, 5, 10, 15, 20, 25, 30, 35, 40, 45, 50, 55, 60, 65, 70, 75, 80, 85, 90, 95, 98, or 99 wt %, or any other number (wt %) between any two numbers (wt %) listed herein of cathode active material based on the total weight of the cathode electrode 102. In embodiments, cathode active material in the cathode electrode 102 may be within a range formed by selecting any two numbers within the range from greater than 0 to about 100 wt %, e.g., between about 40 wt % and about 98 wt %.

### Conductive Material in Cathode Electrode

The conductive material in the cathode electrode 102 is not particularly limited, as long as it has conductivity while not causing any chemical change in the corresponding solid state battery 100. For example, the conductive material can comprise graphite, such as natural graphite or artificial graphite; carbon black, such as acetylene black, ketjen black, channel black, furnace black, lamp black or thermal black; conductive fibers, such as carbon fibers or metal fibers; carbon nanotubes (CNT), including both singled-walled carbon nanotubes (SWCNT) and multi-walled carbon nanotubes (MWCNT); metal powder, such as fluorocarbon, aluminum or nickel powder; conductive whiskers, such as zinc oxide or potassium titanate; conductive metal oxides, such as titanium oxide; conductive polymers, such as polyphenylene derivatives; the like; or combinations thereof.

### Amount of Conductive Material in Cathode Electrode

The cathode electrode 102 includes at or about 1, 3, 4, 5, 6, 7, 8, 9, 10, 11, 12, 13, 14, 15, 16, 17, 18, 19, 20, 21, 22, 23, 24, 25, 26, 27, 28, 29, or 30 wt % of conductive material based on the total weight of the cathode electrode 102. In embodiments, conductive material in the cathode electrode 102 may be within a range formed by selecting any two numbers listed in the immediately previous sentence, e.g., between about 1 wt % and about 30 wt %.

### Materials for Binder

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polymers thereof whose hydrogen atoms are substituted with Li, Na or Ca, various copolymers thereof, the like, or combinations thereof.

### Other Binder Materials

In addition to the binder materials previously mentioned, other types of binder materials may be used in the cathode electrode to enhance its performance and stability. For instance, water-soluble binders such as sodium alginate, gelatin, or polyacrylamide may be employed to improve the environmental friendliness of the electrode manufacturing process. These binders may also offer advantages in terms of electrode flexibility and adhesion strength. In some cases, conductive binders like poly(3,4-ethylenedioxythiophene):poly(styrene sulfonate) (PEDOT:PSS) or polyaniline (PANI) may be used to simultaneously improve both the mechanical integrity and electrical conductivity of the electrode.

### Novel Binder Systems

Novel binder systems, such as self-healing polymers or supramolecular assemblies, may be incorporated to enhance the long-term stability and cycle life of the battery. Additionally, composite binders combining multiple polymers or incorporating inorganic nanoparticles may be utilized to tailor the mechanical, thermal, and electrochemical properties of the electrode. In some embodiments, bio-derived or biodegradable binders, such as cellulose derivatives or chitosan, may be employed to reduce the environmental impact of battery production and disposal.

### Amount of Binder in the Cathode Electrode

The cathode electrode 102 may include at or about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt % of binder based on the total weight of the cathode electrode 102. In embodiments, binder in the cathode electrode 102 may be within a range formed by selecting any two numbers listed in the immediately previous sentence, e.g., between about 1 wt % and about 30 wt %.

### Solid Electrolyte Material

The solid electrolyte material in the cathode electrode 102 can be configured the same as the material for the solid electrolyte layer 106 discussed below. The solid electrolyte material in the cathode electrode 102 can be the same as or different than the material for the solid electrolyte layer 106.

### Amount of Solid Electrolyte Material in Cathode Electrode

The cathode electrode 102 may include about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt % of solid electrolyte material based on the total weight of the cathode electrode 102. In embodiments, the amount of solid electrolyte material in the cathode electrode 102 may be within a range formed by selecting any two numbers listed in the immediately previous sentence, e.g., between about 1 wt % and about 30 wt %.

### Thickness of Cathode Electrode

A thickness, t₂, of the cathode electrode 102 can be at or about any number in a range of from greater than 0 to 1000 μm, such as 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400,410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1,000 μm, or any other number between any two exemplary numbers listed herein. In embodiments, the thickness, t₂, of the cathode electrode 102 may be within a range formed by selecting any two numbers within the range of from greater than 0 to about 1000 μm, e.g., between about 10 μm and about 1,000 μm.

### Porosity of Cathode Electrode

A porosity of the cathode electrode 102 can be at or about any number in a range of from 0 to 20 vol %, such as 0, 1, 2 3, 4, 5, 6, 7, 8, 9, 10, 11, 12, 13, 14, 15, 16, 17, or 18 vol % or any other vol % within the range of 0 to 20 vol %, based on the total volume of the cathode electrode 102. In embodiments, the porosity of the cathode electrode 102 may be within a range formed by selecting any two numbers within the range of 0 to 20 vol %, e.g., between 0 vol % and about 18 vol %.

### Lithium Ion Diffusivity of Cathode Electrode

The cathode electrode 102 can include a lithium ion diffusivity at or about any number in a range of from greater than 0 to 1×10⁻⁷ cm²/s, such as 1×10⁻¹⁴ cm²/s, 1×10⁻¹³ cm²/s, 1×10⁻¹² cm²/s, 1×10⁻¹¹ cm²/s, 1×10⁻¹¹ cm²/s, 1×10⁻⁹ cm²/s, 1×10⁻⁸ cm²/s, or 1×10⁻⁷ cm²/s, or any other number within the range of from greater than 0 to 1×10⁻⁷ cm²/s. In embodiments, the lithium ion diffusivity of the cathode electrode 102 may be within a range formed by selecting any two numbers within the range of from greater than 0 to 1×10⁻⁷ cm²/s, e.g., between 1×10⁻⁴ cm²/s and about 1×10⁻⁷ cm²/s.

### Current Collector at Cathode Electrode

The current collector 108 collects electrical energy generated at the cathode electrode 102 and supports the cathode electrode 102.

### Materials for Current Collector at Cathode Electrode

The material of the current collector 108 is not particularly limited as long as it allows adhesion of the cathode electrode 102, has a suitable electrical conductivity, and does not cause significant chemical changes in the corresponding solid state battery 100 in the voltage range of the solid state battery 100. For example, the current collector 108 is made of or includes various materials, such as, a metal, a conductive carbon, or a conductive ceramic, although not limited thereto. The metal of the current collector 108 may include one or more selected from the group consisting aluminum, an aluminum alloy, copper, a copper alloy, nickel, a nickel alloy, titanium, a titanium alloy, iron, an iron alloy (e.g., steel, stainless steel), silver, a silver alloy, gold, platinum, palladium, chromium, molybdenum, tungsten, tantalum, niobium, zirconium, vanadium, manganese, cobalt, indium, tin, lead, bismuth, or a combination thereof, although not limited thereto.

### Current Collector Geometry

The current collector 108 may also be configured in various other geometries to optimize its performance and integration with the cathode electrode 102, and may be sized for specific form factors, such as pouch, cylindrical, and/or prismatic form factors.

### Shape of Current Collector at Cathode Electrode

It is possible to increase the adhesion of the cathode electrode 102 to the current collector 108 by forming fine surface irregularities on the surface of the current collector 108. The current collector 108 may have various shapes, such as, for example, a film, a sheet, a foil, a net, a porous body, a foam, a non-woven web, the like, or combinations thereof.

### Examples of Shape and Size of Current Collector

For instance, the current collector 108 may be structured as a mesh or grid, which can provide enhanced mechanical support while maintaining high surface area for electrode adhesion. In some embodiments, the current collector 108 may be designed with a corrugated or wavy pattern, potentially increasing the contact area with the cathode material and improving overall conductivity. The current collector 108 may also be fabricated as a perforated sheet, allowing for better electrolyte penetration and ion transport. In certain cases, the current collector 108 may be formed as a three-dimensional structure, such as an interconnected network of fibers or a honeycomb-like configuration, which could enhance the structural integrity of the electrode assembly while facilitating efficient current collection.

### Thickness of Current Collector at Cathode Electrode

A thickness, t₃, of the current collector 108 can be at or about any number in a range of from greater than 0 to 500 μm, such as 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400,410, 420, 430, 440, 450, 460, 470, 480, 490, 500 μm, or any other number between any two exemplary numbers listed herein. In embodiments, the thickness, t₃, of the current collector 108 may be within a range formed by selecting any two numbers within the range of from greater than 0 to 500 μm, e.g., between about 5 μm and about 500 μm.

### Manufacturing Methods for Cathode Electrode

The cathode electrode 102 may be obtained by various methods.

### Dry Powder Coating Process

For instance, a dry powder coating process may be employed, where the cathode active material, conductive additives, and binder are mixed in a dry state and then directly applied to the current collector 108 using electrostatic deposition or mechanical compression. This method may reduce environmental impact by reducing use of solvents.

### 3D Printing

In some cases, the cathode electrode 102 may be fabricated using additive manufacturing techniques such as 3D printing. This approach allows for precise control over the electrode structure and porosity, potentially enhancing the electrode's performance and energy density. Various 3D printing methods, including fused deposition modeling (FDM), selective laser sintering (SLS), or direct ink writing (DIW), may be utilized depending on the specific materials and desired electrode properties.

### Electrospinning

Another method for manufacturing the cathode electrode 102 may involve electrospinning. In this process, a solution containing the cathode active material, conductive additives, and a polymer binder is extruded through a nozzle under an electric field, resulting in the formation of nanofibers. These fibers can be collected directly on the current collector 108 to form a highly porous electrode structure with increased surface area.

### Tape Casting

In some embodiments, the cathode electrode 102 may be prepared using a tape casting method. This technique involves spreading a slurry of electrode materials onto a moving carrier film using a doctor blade, followed by drying and calendaring. The resulting electrode tape can then be laminated onto the current collector 108.

### Spray Coating

Alternatively, the cathode electrode 102 may be fabricated using a spray coating technique. In this method, a fine mist of the electrode slurry is sprayed onto the current collector 108 using compressed air or ultrasonic atomization. This approach may allow for the creation of thin, uniform electrode layers and can be particularly useful for large-scale production.

### Freeze-Casting

In certain cases, the cathode electrode 102 may be manufactured using a freeze-casting method. This process involves freezing a slurry of electrode materials, followed by sublimation of the ice to create a porous structure. The resulting porous electrode can then be sintered and attached to the current collector 108.

### Sol-Gel Process

For some applications, the cathode electrode 102 may be prepared using a sol-gel process. This method involves the formation of a colloidal suspension (sol) that is then converted into a gel-like network containing the cathode active material and other components. The gel can be applied to the current collector 108 and subsequently heat-treated to form the final electrode structure.

### Slurry-Based Process

For example, the cathode active material can be mixed and agitated with a solvent, and optionally a binder, conductive material, and a dispersing agent to form slurry. Then, the slurry can be applied (e.g., coated) onto the current collector 108, followed by pressing and drying, to obtain the cathode electrode 102.

### Application Methods for Slurry for Cathode Electrode

The application of the slurry to the cathode electrode 102 may include using a technique selected from the group consisting of slot die coating, gravure coating, spin coating, spray coating, roll coating, curtain coating, extrusion, casting, screen printing, inkjet printing, spray printing, gravure printing, heat transfer printing, a Toppan printing method, intaglio printing, offset printing, the like, and combinations thereof.

### Double Layer Slot Die Coating

In some embodiments, the cathode electrode 102 may be fabricated using a double layer slot die coating (DLD) technique. This method involves the simultaneous application of two distinct layers of electrode materials onto the current collector 108 in a single pass. The DLD process may allow for the creation of gradient structures within the electrode, potentially optimizing both the electrochemical performance and mechanical properties of the cathode. Additionally, this technique may enable the incorporation of functional interlayers or protective coatings as part of the electrode manufacturing process, potentially enhancing the overall battery performance and longevity.

### Solvent for Slurry for Cathode Electrode

The solvent for forming the cathode electrode 102 may include water and/or an organic solvents, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the cathode active material, binder, and conductive material, considering the slurry coating thickness, production yield, the like, or combinations thereof. Additional solvents that may be used include ethanol, methanol, propanol, butanol, ethyl acetate, methyl ethyl ketone, tetrahydrofuran, diethyl ether, and toluene.

### Solvent-Free Methods

In some aspects of the disclosure, the cathode electrode 102 may be prepared using a solvent-free method, such as dry powder processing or melt extrusion, which reduce the use of liquid solvents and may offer environmental and cost benefits.

### Dispersing Agent for Slurry for Cathode Electrode

The dispersing agent forming the cathode electrode 102 may include an aqueous dispersing agent and/or an organic dispersing agent, such as, for example, N-methyl-2-pyrrolidone. Other possible dispersing agents may include polyvinylpyrrolidone (PVP), carboxymethyl cellulose (CMC), sodium dodecyl sulfate (SDS), Triton X-100, polyethylene glycol (PEG), polyacrylic acid (PAA), and various surfactants such as polysorbates or poloxamers.

### Drying Technique for Slurry for Cathode Electrode

The slurry for the cathode electrode 102 may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the cathode electrode 102.

### Additional Drying Techniques

In addition to the drying techniques mentioned, the cathode electrode 102 may be dried using other methods such as infrared (IR) drying, microwave drying, or freeze-drying.

### Combination of Drying Techniques

In some embodiments, a combination of drying techniques may be employed, such as using convection heating followed by vacuum drying, to optimize the drying process and ensure complete solvent removal while maintaining the integrity of the electrode structure.

### Anode Electrode Generally

The anode electrode 104 is associated with one polarity (e.g., negative) of the solid state battery 100, which is different than the polarity of the cathode electrode 102. The anode electrode 104 is configured as a negative electrode during discharge of the solid state battery 100. The anode electrode 104 is suitable for lithium ion diffusion between a current collector 110 and the solid electrolyte layer 106.

### Anode Electrode Positioning

The anode electrode 104 is in electrical communication with the current collector 110. In embodiments, the anode electrode 104 is formed over and in direct contact with the current collector 110. In other embodiments, another functional layer may be interposed between the anode electrode 104 and the current collector 110.

### Anodeless Electrode System

In some embodiments, as explained above, the solid state battery 100 may utilize an anodeless electrode system. In such configurations, the anode electrode 104 may be omitted, and lithium metal may be deposited directly onto the current collector 110 during charging. This approach may potentially increase the energy density of the battery and eliminate a separate anode material, while also potentially reducing the overall thickness of the battery structure.

### Materials for Anode Electrode

The anode electrode 104 may be capable of reversible intercalation and deintercalation of lithium ions. For example, the anode electrode 104 can comprise an anode active material, a binder, the like, or combinations thereof.

### Additives for Anode Electrode

Optionally, the anode electrode 104 may further comprise an additive, such as, for example, an oxidation stabilizing agent (e.g., butylated hydroxyanisole, butylated hydroxytoluene, propyl gallate, tert-butylhydroquinone), a reduction stabilizing agent (e.g., ascorbic acid, sodium sulfite, erythorbic acid, sodium metabisulfite), a flame retardant (e.g., aluminum hydroxide, magnesium hydroxide, ammonium polyphosphate, melamine cyanurate), a heat or light stabilizer (e.g., phenolic compounds, phosphites, hindered amine light stabilizers, UV absorbers like benzophenones or benzotriazoles), an antifogging agent (e.g., polyethylene glycol, silica nanoparticles, glycerol, sorbitol), a thickener (e.g., carboxymethyl cellulose, xanthan gum), the like, or a combination thereof.

### Other Additives for Anode Electrode

Additionally, conductive additives such as carbon black, graphene, or carbon nanotubes may be incorporated to enhance electrical conductivity, while binder modifiers like styrene-butadiene rubber or polyacrylic acid may improve adhesion and mechanical stability. Functional additives such as fluoroethylene carbonate or vinylene carbonate may also be included to promote the formation of a stable solid electrolyte interphase layer on the anode surface.

### Materials for Anode Active Material

The anode active material is made of or includes various materials, such as, for example, an alkali earth metal, an alkaline earth metal, a group 3B metal, a transition metal, a metalloid, an alloy thereof, a conductive carbon, the like, or a combination thereof, although not limited thereof. In embodiments, the anode active material can comprise silicon, a silicon alloy, lithium, a lithium alloy, a conductive carbon, or a combination thereof, although not limited thereto. In embodiments, the lithium alloy is made of or includes a lithium alloy comprising silicon, chlorine, or a combination thereof. A lithium metal thin film may be used as the anode active material.

### Other Materials Anode Active Materials

The anode active material can include carbon-based material such as artificial graphite, natural graphite, graphitized carbon fiber, amorphous carbon or the like; a metallic compound capable of alloying with lithium such as Si, Al, Sn, Pb, Zn, Bi, In, Mg, Ga, Cd, a Si alloy, a Sn alloy, an Al alloy, or the like; a metal oxide capable of doping and dedoping lithium ions such as SiOₓ (0<x<2), SnO₂, vanadium oxide or lithium vanadium oxide; and a composite including the metallic compound and the carbon-based material such as a Si—C composite or a Sn—C composite.

### Carbon-Based Materials

The carbon-based material can include low-crystallinity carbon, high-crystallinity carbon, the like, or combinations thereof. A representative example of low-crystallinity carbon is soft carbon or hard carbon, and a representative example of the high-crystallinity carbon is high-temperature calcined carbon such as amorphous, platy, flaky, spherical or fibrous natural graphite or artificial graphite, kish graphite, pyrolytic carbon, mesophase pitch-based carbon fiber, meso-carbon microbeads, mesophase pitches, petroleum or coal tar pitch-derived coke, the like, or combinations thereof.

### Metal Carbon Composite Materials

Alternatively, according to aspects of the disclosure, the anode electrode 104 may comprise an anode material with a metal carbon composite, such as a silver-carbon blend or composite, where silver particles are complexed between amorphous and/or crystalline carbon particles. While silver is used as exemplary, other metals may be used, including for example, tin, silicon, zinc, or combinations thereof.

### Further Materials for Anode Active Material

In addition to the materials mentioned, the anode active material may also include titanium-based compounds such as lithium titanate (Li4Ti5O12) or titanium dioxide (TiO2), which can offer excellent cycling stability and high-rate capability. Other potential materials may include transition metal oxides like molybdenum oxides (MoOx), iron oxides (FeOx), or nickel oxides (NiOx), which can provide high theoretical capacities. In some cases, composite materials combining different active materials, such as silicon-graphite composites or tin-carbon composites, may be used to leverage the advantages of multiple materials while mitigating their individual limitations.

### Dendrite Formation

When the anode electrode 104 is made of or includes lithium or a lithium alloy, dendrites may form on the anode electrode 104. The dendrites are a metallic lithium structure formed when extra lithium ions accumulate on a surface of the anode electrode 104. The formed dendrites may damage the solid electrolyte layer 106, reduce battery capacity of the solid state battery 100, and/or otherwise lead to undesired performance of the solid state battery 100. Dendrite formation is a significant challenge in lithium-based batteries, as these structures can grow through the electrolyte, potentially causing short circuits and safety hazards. The growth rate and morphology of dendrites may be influenced by factors such as current density, temperature, and the nature of the electrolyte-electrode interface.

### Advantages of Solid Electrolytes in Mitigating Dendrite Formation

Solid electrolytes offer several advantages over liquid electrolytes when it comes to mitigating dendrite formation. The mechanical strength of solid electrolytes may help suppress dendrite growth by providing a physical barrier to lithium metal penetration. Additionally, the uniform ion distribution in solid electrolytes may promote more even lithium deposition, reducing the likelihood of localized dendrite nucleation. Some solid electrolytes may also form a stable interface with the lithium metal anode, further inhibiting dendrite formation. However, while solid electrolytes can significantly reduce the risk of dendrite growth, they may not completely eliminate it, and ongoing research aims to develop advanced solid electrolyte materials with enhanced dendrite suppression capabilities.

### Shape of Anode Active Material

The anode active material can be particle shaped or it may be a continuous, unitary form (e.g., a thin film or sheet).

### Particle Size

In embodiments where the anode active material is particle shaped, the anode active material can comprise a particle size of any number in a range from at or about 10 nm to at or about 1000 μm, such as at or about 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1000 nm, 2 μm, 3 μm, 4 μm, 5 μm, 6 μm, 7 μm, 8 μm, 9 μm, 10 μm, 15 μm, 20 μm, 25 μm, 30 μm, 35 m, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, 500 μm, 510 μm, 520 μm, 530 μm, 540 μm, 550 μm, 560 μm, 570 μm, 580 μm, 590 μm, 600 μm, 610 μm, 620 μm, 630 μm, 640 μm, 650 μm, 660 μm, 670 μm, 680 μm, 690 μm, 700 μm, 710 μm, 720 μm, 730 μm, 740 μm, 750 μm, 760 μm, 770 μm, 780 μm, 790 μm, 800 μm, 810 μm, 820 μm, 830 μm, 840 μm, 850 μm, 860 μm, 870 μm, 880 μm, 890 μm, 900 μm, 910 μm, 920 μm, 930 μm, 940 μm, 950 μm, 960 μm, 970 μm, 980 μm, 990 μm, or 1,000 μm, or any other number within the range from about 10 nm to about 1000 μm. In embodiments, particle size of the anode active material may be within a range formed by selecting any two numbers in the range of from at or about 10 nm to at or about 1000 am, e.g., between about 10 nm and about 1,000 μm.

### Amount of Anode Active Material in Anode Electrode

The amount of the anode active material in the solid state battery 100 affects the charge and discharge capacity of the solid state battery 100. In order to manufacture a high-capacity anode electrode 104, a high level of anode active material can be included in the anode electrode 104. For example, the anode electrode 104 includes at, about, or greater than 70, 80, 90, 95, 98, 99, or 100 wt % of anode active material based on the total weight of the anode electrode 104. In embodiments, anode active material in the anode electrode 104 may be within a range formed by selecting any two numbers listed in the immediately previous sentence, e.g., between about 70 wt % and about 100 wt %.

### Materials for Binder in Anode Electrode

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polymers thereof whose hydrogen atoms are substituted with Li, Na or Ca, various copolymers thereof, the like, or combinations thereof.

### Examples of Materials for Binder in Anode Electrode

In addition to the binders mentioned, other suitable binders for use in the anode electrode may include polyimide, polyamide-imide, polyurethane, polyethylene oxide (PEO), poly(ethylene-co-vinyl acetate) (PEVA), poly(vinyl acetate) (PVA), alginate, chitosan, guar gum, xanthan gum, carrageenan, pectin, gelatin, lignin, and various water-soluble polymers or their derivatives. In some cases, conductive polymers such as polypyrrole, polyaniline, or poly(3,4-ethylenedioxythiophene) (PEDOT) may also be used as binders to simultaneously improve adhesion and electrical conductivity within the anode electrode.

### Amount of Binder in Anode Electrode

The anode electrode 104 may include at or about 0, 1, 2, 3, 4, 5, 6, 7, 8, 9, 10, 11, 12, 13, 14, 15, 17, 18, 19, 20, 21, 22, 23, 24, 25, 26, 27, 28, 29, or 30 wt %, or any other wt % in the range between 0 and 30 wt % of binder based on the total weight of the anode electrode 104. In embodiments, binder in the anode electrode 104 may be within a range formed by selecting any two numbers in the range between 0 and 30 wt %, e.g., between about 0 wt % and about 30 wt %.

### Thickness of Anode Electrode

The anode electrode 104 can have a thickness of at or about 10, 15, 20, 25, 30, 35, 40, 45, 50, 55, 60, 65, 70, 75, 80, 85, 90, 95, or 100 μm, or any other number between about 10 m and about 100 μm. In embodiments, the thickness, t₄, of the anode electrode 104 may be within a range formed by selecting any two numbers in the range of from 10 μm to about 100 μm, e.g., between about 10 μm and about 100 μm or about 10 μm and about 20 μm.

### Porosity of Anode Electrode

A porosity of the anode electrode 104 can be about 0, 1, 2, 3, 4, 5, 6, 7, 8, 9, 10, 11, 12, 13, 14, 15, 16, 17, or 18 vol %, or any other vol % in the range from 0 to 18 vol %, based on the total volume of the anode electrode 104. In embodiments, the porosity of the anode electrode 104 may be within a range formed by selecting any two numbers in the range from between 0 vol % to about 18 vol %.

### Lithium Ion Diffusivity of Anode Electrode.

The anode electrode 104 may include a lithium ion diffusivity of at or about 1×10⁻¹⁴ cm²/s, 1×10⁻¹³ cm²/s, 1×10⁻¹² cm²/s, 1×10⁻¹¹ cm²/s, 1×10⁻¹¹ cm²/s, 1×10⁻⁹ cm²/s, 1×10⁻⁸ cm²/s, or 1×10⁻⁷ cm²/s, or any other number between at or about 1×10⁻¹⁴ cm²/s and at or about 1×10⁻⁷ cm²/s. In embodiments, the lithium ion diffusivity of the anode electrode 104 may be within a range formed by selecting any two numbers in the range from at or about 1×10⁻¹⁴ cm²/s to at or about 1×10⁻⁷ cm²/s.

### Current Collector at Anode Electrode

The current collector 110 collects electrical energy generated at the anode electrode 104 and supports the anode electrode 104.

### Materials for Current Collector at Anode Electrode

The material of the current collector 110 is not particularly limited as long as it allows adhesion of the anode electrode 104, has a suitable electrical conductivity, and does not cause significant chemical changes in the corresponding solid state battery 100 in the voltage range of the solid state battery 100. For example, the current collector 110 is made of or includes a metal or a conductive carbon, although not limited thereto.

### Metal for Current Collector

The metal of the current collector 110 may include one or more selected from the group consisting aluminum, an aluminum alloy, copper, a copper alloy, nickel, a nickel alloy, titanium, a titanium alloy, iron, an iron alloy (e.g., steel, stainless steel), silver, a silver alloy, or a combination thereof, although not limited thereto.

### Shape of Current Collector at Anode Electrode

It is possible to increase the adhesion of the anode electrode 104 to the current collector 110 by forming fine surface irregularities on the surface of the current collector 110. The current collector 110 may have various shapes, such as, for example, a film, a sheet, a foil, a net, a porous body, a foam, a non-woven web body, the like, or combinations thereof. In addition to the shapes mentioned, the current collector 110 may also be configured as a honeycomb structure, a perforated sheet, a woven or non-woven mesh, a sintered porous body, or a three-dimensional interconnected network. These various shapes can be tailored to optimize the surface area, mechanical strength, and current collection efficiency of the current collector 110.

### Design of Current Collector at Anode Electrode

Furthermore, the current collector 110 may be designed to accommodate different form factors of solid state batteries, such as pouch cells, cylindrical cells, or prismatic cells, each may offer advantages in terms of packaging efficiency, thermal management, and overall battery performance.

### Thickness of Current Collector at Anode Electrode

A thickness, t₅, of the current collector 110 can be at or about 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 μm, or any other number in the range of from at or about 1 μm to at or about 500 μm. In embodiments, the thickness, t₅, of the current collector 110 may be within a range formed by selecting any two numbers listed in the range of from at or about 1 μm to at or about 500 μm, e.g., between about 5 μm and about 500 μm.

### Manufacturing Methods for Anode Electrode

The anode electrode 104 may be obtained by various methods, such as, for example, atomic deposition, extrusion, rolling, a slurry method, or a combination thereof. In addition to the methods mentioned, the anode electrode 104 may be manufactured using various other techniques, including dry electrode processes. These alternative methods may offer advantages in terms of environmental impact, cost-effectiveness, and scalability.

### Dry Powder Coating

Dry powder coating may be employed as an alternative to the slurry method. In this process, the anode active material, conductive additives, and binder are mixed in a dry state and then directly applied to the current collector 110 using electrostatic deposition or mechanical compression. This method may reduce the use of solvents, potentially reducing environmental impact and processing time.

### 3D Printing

Additive manufacturing techniques, such as 3D printing, may be used to fabricate the anode electrode 104. Various 3D printing methods, including fused deposition modeling (FDM), selective laser sintering (SLS), or direct ink writing (DIW), can be utilized depending on the specific materials and desired electrode properties. This approach allows for precise control over the electrode structure and porosity.

### Electrospinning

Electrospinning is another potential method for manufacturing the anode electrode 104. In this process, a solution containing the anode active material, conductive additives, and a polymer binder is extruded through a nozzle under an electric field, resulting in the formation of nanofibers. These fibers can be collected directly on the current collector 110 to form a highly porous electrode structure with increased surface area.

### Tape Casting

Tape casting may be employed to prepare the anode electrode 104. This technique involves spreading a slurry of electrode materials onto a moving carrier film using a doctor blade, followed by drying and calendaring. The resulting electrode tape can then be laminated onto the current collector 110.

### Spray Coating

Spray coating techniques may be used to fabricate the anode electrode 104. A fine mist of the electrode slurry is sprayed onto the current collector 110 using compressed air or ultrasonic atomization. This approach may allow for the creation of thin, uniform electrode layers and can be particularly useful for large-scale production.

### Freeze-Casting

Freeze-casting is another potential method for manufacturing the anode electrode 104. This process involves freezing a slurry of electrode materials, followed by sublimation of the ice to create a porous structure. The resulting porous electrode can then be sintered and attached to the current collector 110.

### Sol-Gel Process

In some cases, a sol-gel process may be used to prepare the anode electrode 104. This method involves the formation of a colloidal suspension (sol) that is then converted into a gel-like network containing the anode active material and other components. The gel can be applied to the current collector 110 and subsequently heat-treated to form the final electrode structure.

### Vapor Deposition

For certain applications, physical vapor deposition (PVD) or chemical vapor deposition (CVD) techniques may be employed to create thin film anodes directly on the current collector 110. These methods can produce highly uniform and dense electrode layers, which may be particularly beneficial for certain types of solid-state batteries.

### Alloying and Ball Milling

Mechanical alloying and high-energy ball milling may be used to prepare composite anode materials, which can then be pressed into electrodes or applied to the current collector 110 using one of the aforementioned methods. This technique can be particularly useful for creating nanostructured or amorphous anode materials with enhanced electrochemical properties.

### Slurry Method

For example, the anode active material can be mixed and agitated with a solvent, and optionally a binder, and a dispersing agent to form slurry. Then, the slurry can be applied (e.g., coated) onto the current collector 110, followed by pressing and drying, to obtain the anode electrode 104.

### Application Methods for Slurry for Anode Electrode

The application of the slurry for the anode electrode 104 may include using a technique selected from the group consisting of slot die coating, gravure coating, spin coating, spray coating, roll coating, curtain coating, extrusion, casting, screen printing, inkjet printing, spray printing, gravure printing, heat transfer printing, a Toppan printing method, intaglio printing, offset printing, the like, and combinations thereof. In addition to the aforementioned techniques, other methods for applying the anode slurry to the current collector may include doctor blade coating, dip coating, and meniscus coating.

### Double Slot Die Layer Coating

Double slot die layer coating may also be employed, which allows for the simultaneous application of two distinct layers of electrode materials onto the current collector in a single pass. This method can potentially enable the creation of gradient structures within the electrode, optimizing both electrochemical performance and mechanical properties.

### Solvent for Slurry for Anode Electrode

The solvent for forming the anode electrode 104 may include water and/or an organic solvents, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the anode active material and binder, considering the slurry coating thickness, production yield, the like, or combinations thereof. Additional organic solvents that may be used include ethanol, methanol, propanol, butanol, ethyl acetate, methyl ethyl ketone, tetrahydrofuran, diethyl ether, and toluene.

### Solvent-Free Methods

In some embodiments, the anode electrode 104 may be prepared using a solvent-free method, such as dry powder processing or melt extrusion, which eliminates the need for liquid solvents and may offer environmental and cost benefits.

### Dispersing Agent for Slurry for Anode Electrode

The dispersing agent forming the anode electrode 104 may include an aqueous dispersing agent and/or an organic dispersing agent, such as, for example, N-methyl-2-pyrrolidone. Other examples of aqueous dispersing agents may include sodium dodecyl sulfate (SDS), polyvinylpyrrolidone (PVP), and carboxymethyl cellulose (CMC), while additional organic dispersing agents may include Triton X-100, polyethylene glycol (PEG), and various surfactants such as polysorbates or poloxamers.

Methods without a Dispersing Agent

In some embodiments, the anode electrode 104 may be prepared using methods that do not require a dispersing agent, such as dry powder processing or certain additive manufacturing techniques.

### Drying Technique for Slurry for Anode Electrode

The slurry for the anode electrode 104 may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the anode electrode 104.

### Other Drying Techniques

In addition to the drying techniques mentioned, several other methods may be employed to dry the anode electrode slurry. These additional techniques can offer various advantages depending on the specific materials, production requirements, and desired electrode properties.

### Infrared (IR) Drying

Infrared (IR) drying may be used to rapidly heat the electrode surface, promoting efficient solvent evaporation. This method can be particularly effective for thin electrode coatings and may allow for precise control of the drying process.

### Microwave Drying

Microwave drying is another option that can provide volumetric heating of the electrode material, potentially leading to more uniform drying throughout the electrode thickness. In some cases, a combination of convection and microwave drying may be employed to optimize both drying speed and uniformity.

### Freeze-Drying

Freeze-drying, also known as lyophilization, may be utilized for certain electrode formulations. This process involves freezing the slurry and then sublimating the solvent under vacuum conditions. Freeze-drying can help maintain the porous structure of the electrode, which may be beneficial for electrolyte penetration and ion transport.

### Supercritical CO2 Drying

Supercritical CO₂ drying is an advanced technique that may be employed for specialized electrode materials. This method involves replacing the solvent with liquid CO₂, which is then brought to its supercritical state and vented. This approach can help preserve delicate nanostructures within the electrode and may be particularly useful for aerogel-based electrodes.

### Two-Step Drying

In some cases, a two-step drying process may be employed. For example, initial drying may be performed at a lower temperature to remove bulk solvent, followed by a higher temperature step to remove residual solvent and potentially initiate any desired chemical reactions within the electrode material.

### Ultrasonic Drying

Ultrasonic drying may also be considered for certain electrode formulations. This technique uses high-frequency sound waves to agitate the solvent molecules, potentially accelerating the drying process and improving solvent removal from porous structures within the electrode.

### Solid Electrolyte Layer Generally

The solid electrolyte layer 106 is suitable for lithium ion diffusion between the cathode electrode 102 and the anode electrode 104. The solid electrolyte layer 106 provides an electrically conductive pathway for the movement of charge carriers between the cathode electrode 102 and the anode electrode 104. The solid electrolyte layer 106 is in electrical communication with the cathode electrode 102 and the anode electrode 104.

### Solid Electrolyte Positioning

In embodiments, the solid electrolyte layer 106 is formed over and in direct contact with the cathode electrode 102 or the anode electrode 104. In embodiments, the solid electrolyte layer 106 is in direct contact with the cathode electrode 102 and the anode electrode 104. In other embodiments, another functional layer may be interposed between the solid electrolyte layer 106 and the cathode electrode 102 and/or the anode electrode 104.

### Materials for Solid Electrolyte Layer

The solid electrolyte layer 106 may be capable of transport of lithium ions. The material of the solid electrolyte layer 106 is not particularly limited as long as it allows adhesion with adjacent layers, has a suitable electrical conductivity, and does not cause significant chemical changes in the corresponding solid state battery 100 in the voltage range of the solid state battery 100. For example, the solid electrolyte layer 106 may include various inorganic solid electrolytes, polymer solid electrolytes, and/or polymer gel electrolytes, although not limited thereto. Additionally or alternatively, the solid electrolyte layer 106 may include ceramic electrolytes, glass electrolytes, hybrid organic-inorganic electrolytes, and nanostructured electrolytes, although not limited to these categories.

### Inorganic Solid Electrolyte

The inorganic solid electrolyte may include a crystalline solid electrolyte, a non-crystalline solid electrolyte, a glass ceramic solid electrolyte, the like, or a combination thereof, although not limited thereto. The inorganic solid electrolyte may be sulfide-based, oxide-based, the like, or a combination thereof. In addition to sulfide-based and oxide-based inorganic solid electrolytes, other types of inorganic solid electrolytes may include halide-based electrolytes, nitride-based electrolytes, and borate-based electrolytes. For example, lithium-rich anti-perovskites (LiRAP) such as Li3OCl and Li3OBr, lithium nitride (Li3N), and lithium borohydride (LiBH4) have been investigated as potential solid electrolyte materials for lithium-ion batteries.

### Sulfide Based Solid Electrolyte

The sulfide-based solid electrolyte includes sulfur (S) and has ionic conductivity of metal belonging to Group I or Group II of the periodic table, and may include Li—P—S-based glass or Li—P—S-based glass ceramics.

### Examples of Sulfide-Based Solid Electrolyte

For example, the sulfide-based solid electrolyte may include lithium sulfide, silicon sulfide, germanium sulfide and boron sulfide. Particular examples of the inorganic solid electrolyte may include Li_{3.833}Sn_{0.833}As_{0.166}S₄, Li₄SnS₄, Li_{3.25}Ge_{0.25}P_{0.75}S₄, Li₂S—P₂S₀, B₂S₃—Li₂S, XLi₂S-(100-x)P₂S₅ (x=70-80), Li₂S—SiS₂—Li₃N, Li₂S—P₂S₅—LiI, Li₂S—SiS₂—LiI, Li₂S—B₂S₃—LiI, Li₃N, LISICON, LIPON (Li_{3+y}PO₄₋ₓNₓ), thio-LISICON (Li_{3.25}Ge_{0.25}P_{0.75}S₄), Li₂O—Al₂O₃—TiO₂—P₂O₅(LATP), Li₂S—P₂S₅, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li10GeP2S12 (LGPS), Li7P3S11, Li6PS5Cl, Li6PS5Br, Li6PS5I, Li9.54Si1.74P1.44S11.7Cl0.3, Li11Si2PS12, the like, or combinations thereof.

### Doped Variants

In some cases, doped variants of these materials, such as Al-doped Li10GeP2S12 or Sb-doped Li6PS5Cl, may also be employed to further enhance ionic conductivity or stability.

### Oxide Based Solid Electrolyte

The oxide-based solid electrolyte material contains oxygen (O) and has ionic conductivity of metal belonging to Group I or II of the periodic table.

### Examples of Oxide-Based Solid Electrolyte Material

The oxide-based solid electrolyte material may include at least one selected from the group consisting of LLTO-based compounds, Li₆La₂CaTa₂O₁₂, Li₆La₂ANb₂O₁₂ (A is Ca or Sr), Li₂Nd₃TeSbO₁₂, Li₃BO_{2.5}N_{0.5}, Li₉SiA₁O₈, LAGP-based compounds, LATP-based compounds, Li₁₊ₓTi₂₋ₓAlₓSi_{y}(PO₄)_{3-y} (0≤x≤1, 0≤y≤1), LiAlₓZr₂₋ₓ(PO₄)₃ (0≤x≤1, 0≤y≤1), LiTiₓZr₂₋ₓ(PO₄)₃ (0≤x≤1, 0≤y≤1), LISICON-based compounds, LIPON-based compounds, perovskite-based compounds, NASICON-based compounds and LLZO-based or derived compounds (such as Al-doped Li7La3Zr2O12 and Ta-doped Li7La3Zr2O12). Lithium-rich anti-perovskites like Li3OCl and Li3OBr have also been investigated as potential oxide-based solid electrolytes.

### Composite Oxide Electrolyte

In some cases, composite oxide electrolytes combining multiple oxide materials, such as LLZO-LATP composites, may be employed to leverage the advantages of different oxide systems.

### Polymer Solid Electrolyte

The polymer solid electrolyte is a composite of electrolyte salt with polymer resin and has lithium ion conductivity. The polymer solid electrolyte may include a polyether polymer, a polycarbonate polymer, an acrylate polymer, a polysiloxane polymer, a phosphazene polymer, a polyethylene derivative, an alkylene oxide derivative, a phosphate polymer, a polyagitation lysine, a polyester sulfide, a polyvinyl alcohol, a polyvinylidene fluoride, a polymer containing an ionically dissociable group, poly(ethylene imine) (PEI), poly(methyl methacrylate) (PMMA), poly(acrylonitrile) (PAN), poly(ethylene succinate) (PES), biopolymers such as chitosan and cellulose derivatives, the like, or combinations thereof.

### Polymer Resin for the Solid Polymer Electrolyte

The solid polymer electrolyte may include a polymer resin, such as a branched copolymer including polyethylene oxide (PEO) backbone copolymerized with a comonomer including an amorphous polymer, such as, for example, PMMA, polycarbonate, polydiloxane (pdms) and/or phosphazene, comb-like polymer, crosslinked polymer resin, polyethylene glycol (PEG), polypropylene oxide (PPO), polyacrylonitrile (PAN), poly(methyl methacrylate) (PMMA), poly(vinylidene fluoride-co-hexafluoropropylene) (PVDF-HFP), poly(ethylene oxide-co-propylene oxide) (PEO-PPO), poly(ethylene imine) (PEI), poly(vinyl pyrrolidone) (PVP), poly(vinyl alcohol) (PVA), various block copolymers or graft copolymers incorporating these materials, the like, or combinations thereof.

### Polymer Gel Electrolyte

The polymer gel electrolyte can be formed by incorporating an organic electrolyte containing an organic solvent and an electrolyte salt, an ionic liquid, monomer, or oligomer to a polymer resin, the like, or combinations thereof. The polymer resin for the polymer gel can include polyether polymers, PVC polymers, PMMA polymers, polyacrylonitrile (PAN), polyvinylidene fluoride (PVDF), poly(vinylidene fluoride-co-hexafluoropropylene: PVDF-co-HFP), the like, or combinations thereof.

### Examples of Polymer Gel Electrolyte

Examples of polymer gel electrolytes that may be suitable for solid state batteries include poly(ethylene oxide) (PEO), poly(methyl methacrylate-co-ethyl acrylate) (PMMA-EA), poly(acrylonitrile-co-methyl methacrylate) (PAN-MMA), poly(vinyl acetate) (PVAc), poly(ethylene glycol diacrylate) (PEGDA), poly(vinyl pyrrolidone) (PVP), poly(ethylene glycol methyl ether acrylate) (PEGMEA), poly(ethylene glycol methyl ether methacrylate) (PEGMEMA), poly(ionic liquid) (PIL), poly(ethylene glycol-co-propylene glycol) (PEG-PPG), poly(vinyl alcohol-co-ethylene) (PVA-PE), poly(acrylamide) (PAM), poly(2-hydroxyethyl methacrylate) (PHEMA), poly(ethylene glycol-co-polyethylene oxide) (PEG-PEO), and poly(methacrylic acid) (PMAA) based gel electrolytes to optimize the electrochemical and physical properties of the solid electrolyte.

### Electrolyte Salt

The electrolyte salt is an ionizable lithium salt and may be represented by Li⁺X⁻. X⁻ may include an anion selected from the group consisting of F⁻, Cl⁻, Br⁻, NO₃⁻, N(CN)₂⁻, BF₄⁻, ClO₄⁻, AlG₄⁻, AlCl₄⁻, PF₆⁻, SbF₆⁻, AsF₆⁻, BF₂C₂O₄⁻, BC₄O₈⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (F₂SO₂)₂N⁻, CF₃CF₂(CF₃)₂CO⁻, (CF₃SO₂)₂CH, CF₃(CF₂)₇SO₃⁻, CF₃CO₂⁻, CH₃CO₂⁻, SCN⁻, (CF₃CF₂SO₂)₂N⁻, and the like.

### Examples of Lithium Salt

For example, the lithium salt may be any one selected from the group consisting of LiTFSI, LiCl, LiBr, LiI, LiClO₄, lithium tetrafluoroborate (LiBF₄), LiB₁₀Cl₁₀, lithium hexafluorophosphate (LiPF₆), LiAsF₆, LiSbF₆, LiAlCl₄, LiSCN, LiCF₃CO₂, LiCH₃SO₃, LiCF₃SO₃, LiN(SO₂CF₃)₂, LiN(SO₂C₂F₅)₂, LiC₄F₉SO₃, LiC(CF₃SO₂)₃, (CF₃SO₂)₂NLi, lithium chloroborate, lithium lower aliphatic carboxylate, lithium imide 4-phenylborate, lithium bis(oxalato)borate (LiBOB), lithium difluoro(oxalato)borate (LiDFOB), lithium bis(fluorosulfonyl)imide (LiFSI), lithium 4,5-dicyano-2-(trifluoromethyl)imidazolide (LiTDI), lithium bis(trifluoromethanesulfonyl)imide (LiTFSI), and lithium bis(fluorosulfonyl)imide (LiFSI), the like, and combinations thereof. The electrolyte salt can include any combination of the salts described herein.

### Amount of Electrolyte Salt

The solid electrolyte layer 106 can include at or about 0, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, or 400 parts, or any other number between 0 and 400 parts, of electrolyte salt, if present, based on the total weight of the solid electrolyte layer 106. In embodiments, electrolyte salt in the solid electrolyte layer 106 may be within a range formed by selecting any two numbers between about 0 parts and about 400 parts, or about 60 parts and 400 parts, based on the total weight of the solid electrolyte layer 106.

### Ion Conductivity of Solid Electrolyte Layer

The solid electrolyte layer 106 may have a suitable reduction stability and/or ion conductivity. Since the solid electrolyte layer 106 mainly functions to transport lithium ions between electrodes, the solid electrolyte layer 106 can include a desirable ion conductivity of at, about, or greater than, for example, 10⁻⁷ S/cm, 10⁻⁶ S/cm, 10⁻⁵ S/cm, or 10⁻⁴ S/cm, or any other number greater than about 10⁻⁷ S/cm.

### Thickness of Solid Electrolyte Layer

A thickness, t₆, of the solid electrolyte layer 106 can be at or about 1, 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850,860, 870, 880, 890, 900, 910, 920, 930, 940, 950, 960, 970, 980, 990, or 1,000 μm, or any other number between 0 and at or about 1,000 μm. In embodiments, the thickness, t₆, of the solid electrolyte layer 106 may be within a range formed by selecting any two numbers in the range of between 0 and at or about 1,000 μm, e.g., between about 5 μm and about 1,000 μm, about 30 μm and about 100 μm, or about 30 μm and about 50 μm.

### Unfinished Product

The cell 101 as shown in FIG. 1 can be provided as an unfinished product. In embodiments, the cell 101 is stored, transported, and/or delivered to a reseller, customer, or the like that finishes manufacture of a battery assembly or product comprising the cell 101. In other embodiments, the cell 101 is a finished battery assembly or product.

### Sealing Battery

An enclosure 112 of the solid state battery can be sealed to finish making the solid state battery 100 such that it will work as a battery. The sealing process may involve various techniques to ensure the internal components are protected from external environmental factors and to maintain the integrity of the battery structure. For example, the enclosure 112 may be hermetically sealed using methods such as laser welding, ultrasonic welding, or adhesive bonding. In some cases, the sealing process may also include the introduction of a protective atmosphere or the removal of air to create a vacuum within the enclosure. This sealing step may be helpful for preventing moisture ingress, which could potentially degrade the performance of the sulfide-based solid electrolyte. Additionally, the sealing process may incorporate safety features such as pressure relief mechanisms to manage any potential gas build-up during battery operation.

### After Sealing Battery

Once properly sealed, the solid state battery 100 is ready for final quality control checks, which may include electrical testing, leak detection, and visual inspections. After passing these checks, the solid state battery 100 could be packaged and sold as a finished product, ready for integration into various electronic devices, electric vehicles, energy storage systems, and so forth.

### Battery Configuration

The solid state battery 100 is provided in various configurations to suit different applications and device requirements. In some aspects, the battery may be manufactured in a cylindrical form, which can be advantageous for certain types of portable electronics or automotive applications. Alternatively, the solid state battery 100 may be produced in a prismatic form, which can allow for more efficient space utilization in devices with rectangular form factors. In other cases, a pouch form may be employed, offering flexibility in shape and potentially reducing overall battery weight. The pouch form may further be especially suitable for solid state batteries due to easier application and control of uniform pressures within the battery.

### Choice of Configuration

The choice of configuration may depend on factors such as the intended use, space constraints, thermal management requirements, and manufacturing considerations. In some embodiments, hybrid or custom configurations combining elements of different forms may be utilized as desired. The versatility in battery form factors can enable the integration of solid state batteries into a wide range of products, from small wearable devices to large-scale energy storage systems.

### Voltage

The solid state battery 100 is configured to output a voltage of at or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 48, 50, 55, 60, 65, 70, 75, 80, 85, 90, 95, 96, 100, 110, 120, 130, 140, 150, 160, 170, 180, 190, 200, 210, 220, 230, 240, 250, 260, 270, 280, 290, 300, 310, 320, 330, 340, 350, 360, 370. 380, 390, 400, 410, 420, 430, 440, 450, 460, 470, 480, 490, or 500 V, or any other number between 0 and at or about 500 V DC. In embodiments, the output voltage of the solid state battery 100 may be within a range formed by selecting any two numbers in the range of between 0 and at or about 500 V, e.g., between about 1 V DC and about 500 V DC.

### Capacity

The solid state battery 100 may be configured to have a capacity of at, about, or greater than 100, 110, 120, 130, 140, 150, 160, 170, 180, 190, 200, 210, 220, 230, 240, 250, 260, 270, 280, 290, or 300 mAh/g, or any other number between 0 and 300 mAh/g or between 0 and about 300 mAh/g. In embodiments, the output voltage of the solid state battery 100 may have a capacity formed by selecting any two numbers in the range of between 0 and 300 mAh/g or between 0 and about 300 mAh/g, e.g., between about 100 mAh/g and about 300 mAh/g.

### Volume Expansion Calculation

The solid state battery 100 may be configured to have a desirable volume expansion rate. The volume expansion rate may be calculated from a change in thickness after the first cycle of charging and discharging compared to the initial thickness. The volume expansion rate may be a ratio of the thickness change to the initial thickness. A first cycle of charging and discharging is performed by CC-CV charging a battery at 0.1 C and cutting off at 4.25 to 4.4 V and 0.02 C, and CC discharging the battery at 0.1 C and cutting off at 3 V. The volume expansion rate is calculated by Equation 1 below in which A may represent a thickness before charging and discharging and B may represent a thickness after charging and discharging. The thickness may be measured using a Mauser micrometer or a scanning electron microscope (SEM).

Volume expansion rate=[(B−A)/A]×100 Equation 1:

### C-Rate

C-rate as used herein refers to the rate at which the battery is discharged relative to its maximum capacity. For example, a 1 C rate means the discharge current will discharge the entire battery within one hour. That is, for a battery with a capacity of 20 Amp-hrs, a discharge current at a 1C would be 20 Amps.

### Other Examples for Volumetric Expansion

Other exemplary ways to measure and calculate the volume expansion rate for a solid state battery may include using volumetric expansion measurement (e.g., gas pycnometry), in-situ dilatometry, X-ray tomography, strain gauge measurements, optical methods (e.g., digital image correlation or laser interferometry), pressure-based methods, and electrochemical strain microscopy.

### EXAMPLES

Examples will be described more fully hereinafter so that the present disclosure can be understood with ease. However, the following examples are for illustrative purposes only and the scope of the present disclosure is not limited thereto.

### Example 1

### Example 1.1: Al-Containing Film

Al particles are obtained from Sigma-Aldrich. Poly(styrene-ethylene/butylene-styrene) block copolymer polymer binder is obtained from Signa-Aldrich. 1 g of the Al particles and 0.001 g of the polymer binder are added to 0.5 ml of Xylene to prepare a slurry. The slurry is spread on top of Cu foil using a doctor blade. The substrate with the slurry top layer is dried at 80° C. (temperature) for 2 hours (duration) to form an Al-containing film, as illustrated in FIG. 1. The obtained Al-containing film has a thickness of 50 μm, as measured by scanning electron microscopy (SEM).

### Example 1.2: Li Foil

A Li foil is obtained from Honjo chemical corporation. The Li foil has a thickness of m and is integrated with a Cu substrate of 12 μm.

### Example 1.3: Anode Assembly

The Al-containing film from Example 1.1 is overlaid on top of the Li foil from Example 1.2.

### Example 1.4: Alloy Anode

The assembly from Example 1.3 is pressed under 250 MPa for 1 hr.

### Example 1.5: Characterization of Alloy Anode

### Example 1.5.1: Alloy Phases

XRD is conducted for the LiAl alloy anode obtained in Example 1.4. FIG. 6 is the XRD spectra of this LiAl alloy anode. FIG. 8 is the XRD spectra of the LiAl alloy anode fabricated by 3 different pressing condition, at 125, 250 and 400 MPa, respectively, for 30 minutes.

### Example 1.5.2: SEM

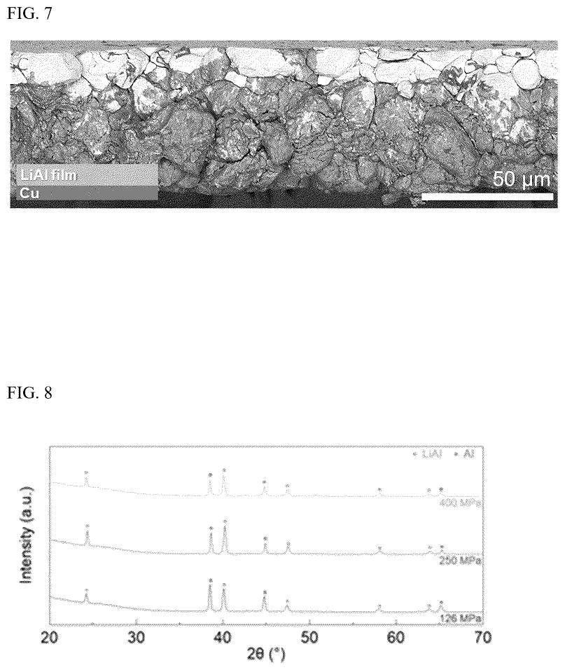

SEM is conducted on the alloy anode from Example 1.4. FIG. 7 is the SEM image of the anode.

### Example 1.5.3: Thickness

The thickness of the anode layer from Example 1.4 is measured by SEM. The result shows that the anode layer has a thickness of 50 μm.

### Example 2

### Example 2.1: Al-Containing Film

Example 1.1 is repeated.

### Example 2.2: Li Foil

A free-standing 50 μm of Li foil is used.

### Example 2.3: Anode Assembly

An anode assembly is prepared using a Li foil of 50 μm sandwiched between two Al-containing film as illustrated in FIG. 2.

### Example 2.4: Alloy Anode

The anode assembly from Example 2.3 is passed through the gap of 200 μm between two rollers. The Cu foils attached on both sides of the anode assembly are then peeled off.

### Example 2.5: Characterization of Alloy Anode

### Example 2.5.1: SEM

FIG. 3 is a SEM of a cross-section of the anode formed in Example 2.4, which shows the Al particles broken down to smaller particles due to lithiation.

### Example 2.5.2: Thickness

From the SEM for the anode from Example 2.5.1, it is measured that the formed anode has a thickness of 91 μm.

### Example 3

### Example 3.1: Battery Assembly with Anode from Example 1.4

A cathode layer of NCM811 is provided. A solid electrolyte layer of LSPCl is provided. The cathode layer, the solid electrolyte layer, and the anode from Example 1.4 are placed in a Titanium jig cell, and the assembly is then pressed under a pressure of 3 ton at room temperature for 3 minutes.

### Example 3.2: Testing Battery from Example 3.1

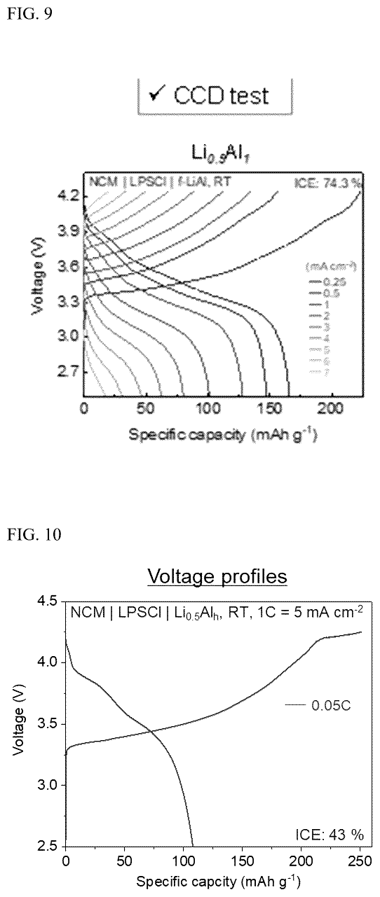

A CCD test is conducted for the battery prepared in Example 3.1, and the results are shown in FIG. 9.

### Example 4

### Example 4.1: Battery Assembly with Anode from Example 2.4

A cathode layer of NCM811 is provided. A solid electrolyte layer of LSPCl is provided. The cathode layer, the solid electrolyte layer, and the anode from Example 2.4 are placed in a Titanium jig cell, and the assembly is then pressed under a pressure of 3 ton at room temperature for 3 minutes.

### Example 4.2: Testing Battery from Example 4.1

A charge-discharge test is conducted for the battery prepared in Example 4.1, and the results are shown in FIG. 10.

### Combinations and Characteristics Included

Various features and characteristics are described in this specification to provide an understanding of the composition, structure, production, function, and/or operation of the present disclosure, which includes the disclosed compositions, coatings, and methods. It is understood that the various features and characteristics of the present disclosure described in this specification can be combined in any suitable manner, regardless of whether such features and characteristics are expressly described in combination in this specification. The Inventors and the Applicant expressly intend such combinations of features and characteristics to be included within the scope of the present disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

### INCORPORATED BY REFERENCE

Any patent, publication, or other document identified in this specification is incorporated by reference into this specification in its entirety unless otherwise indicated but only to the extent that the incorporated material does not conflict with existing descriptions, definitions, statements, illustrations, or other disclosure material expressly set forth in this specification. As such, and to the extent necessary, the express disclosure as set forth in this specification supersedes any conflicting material incorporated by reference. Any material, or portion thereof, that is incorporated by reference into this specification but that conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference. The amendment of this specification to add such incorporated subject matter will comply with the written description, sufficiency of description, and added matter requirements.

### ILLUSTRATION OF VARIOUS ASPECTS

While the present disclosure provides descriptions of various specific aspects for the purpose of illustrating various aspects of the present disclosure and/or its potential applications, it is understood that variations and modifications will occur to those skilled in the art. Accordingly, the present disclosure herein should be understood to be at least as broad as claimed and not as more narrowly defined by particular illustrative aspects provided herein.

What is claimed is:

1. An anode comprising:
a current collector;
an anode active material layer comprising a polymer binder and particles containing lithium-aluminum alloy (LiAl) (hereinafter “LiAl-containing particles”),
wherein the anode active material layer has a first surface facing away from the current collector and a second surface facing the current collector;
wherein the closer to the second surface along a direction from the first surface to the second surface within the anode active material layer, generally the more lithium the LiAl-containing particles contain,
wherein the closer to the second surface along the direction within the anode active material layer, generally the smaller the LiAl-containing particles are, and
wherein the closer to the second surface along the direction within the anode active material layer, generally the less round the LiAl-containing particles are; and
wherein molecules of the polymer binder are distributed generally throughout the anode active material layer such that a portion of at least part of the molecules of the polymer binder is interposed between two adjacent LiAl-containing particles within the anode active material layer.

2. The anode of claim 1 further comprising Al particles on the first surface.

3. The anode of claim 1 further comprising Li metal on the second surface.

4. The anode of claim 1, wherein the LiAl-containing particles have a Li:Al molar ratio of from about 0.1 to about 5.

5. The anode of claim 1, wherein the LiAl-containing particles have a Li:Al molar ratio of from about 0.5 to about 1.

6. The anode of claim 1, wherein the LiAl-containing particles have a Li:Al molar ratio of from about 0.5.

7. The anode of claim 1, wherein the polymer binder comprises at least one polymer selected from the group consisting of polyvinylidene fluoride (PVDF), polyvinyl alcohol (PVA), polyethylene oxide (PEO), polyacrylonitrile (PAN), polyimide (PI), carboxymethyl cellulose (CMC), succinonitrile-based polymers, styrene-butadiene rubber (SBR), polyethylene glycol (PEG), polyvinyl acetate (PVAc), polyurethane (PU), polyacrylic acid (PAA), ionic polymers, gel polymers, hydroxypropyl methylcellulose, methyl cellulose, starch, modified starches, and acrylic emulsion polymers.

8. A method of making an anode, the method comprising:
providing an Al-containing film comprising Al particles and a polymer binder;
overlaying the Al-containing film with a Li foil, such that a surface of the Al-containing film and a surface of the Li foil contact each other; and
pressing the Al-containing film and the Li foil together to form the anode,
such that at least part of Li metal in the Li foil moves toward the Al-containing film,
such that at least part of the Al particles in the Al-containing film move toward the Li foil, and
such that the Li metal contacts surfaces of the Al particles to form particles containing lithium-aluminum alloy (LiAl) (hereinafter “LiAl-containing particles”),
wherein the anode comprises
a current collector;
an anode active material layer comprising a polymer binder and particles containing lithium-aluminum alloy (LiAl) (hereinafter “LiAl-containing particles”),
wherein the anode active material layer has a first surface facing away from the current collector and a second surface facing the current collector;
wherein the closer to the second surface along a direction from the first surface to the second surface within the anode active material layer, generally the more lithium the LiAl-containing particles contain,
wherein the closer to the second surface along the direction within the anode active material layer, generally the smaller the LiAl-containing particles are, and
wherein the closer to the second surface along the direction within the anode active material layer, generally the less round the LiAl-containing particles are; and
wherein molecules of the polymer binder are distributed generally throughout the anode active material layer such that a portion of at least part of the molecules of the polymer binder is interposed between two adjacent LiAl-containing particles within the anode active material layer.

9. The method of claim 8 comprising preparing the Al-containing film, which comprises:
preparing a solution or slurry comprising the Al particles, a solvent, and the polymer binder;
providing a layer of the solution or slurry on top of a substrate;
drying the layer of the solution or slurry on the substrate to form the Al-containing film, wherein the Al-containing film has a substantially homogenous thickness.

10. The method of claim 8, wherein the polymer binder comprises at least one polymer selected from the group consisting of polyvinylidene fluoride (PVDF), polyvinyl alcohol (PVA), polyethylene oxide (PEO), polyacrylonitrile (PAN), polyimide (PI), carboxymethyl cellulose (CMC), succinonitrile-based polymers, styrene-butadiene rubber (SBR), polyethylene glycol (PEG), polyvinyl acetate (PVAc), polyurethane (PU), polyacrylic acid (PAA), ionic polymers, gel polymers, hydroxypropyl methylcellulose, methyl cellulose, starch, modified starches, and acrylic emulsion polymers.

11. The method of claim 8, wherein the polymer binder is in an amount of about 0.1~10 wt % based on a total weight of the Al particles.

12. The method of claim 8, wherein the Li foil has a thickness from about 0.1 μm to about 10 μm.

13. The method of claim 8, wherein the Al-containing film and the Li foil are pressed under a pressure from about 100 MPa to about 500 MPa.

14. The method of claim 8, wherein the Al-containing film and the Li foil are pressed under a pressure from about 125 MPa to about 400 MPa.

15. The method of claim 8, wherein the Al-containing film and the Li foil are pressed for about 5 minutes to about 1 hour.

16. The method of claim 8, wherein the Al-containing film and the Li foil are pressed for about 10 minutes to about 30 minutes.

17. The method of claim 8, wherein the Al-containing film and the Li foil are pressed at a temperature from about 20° C. to about 150° C.

18. The method of claim 8, wherein the Al-containing film and the Li foil are pressed at a temperature from about 50° C. to about 100° C.

19. An all-solid-state battery comprising:
an anode;
a cathode; and
a solid electrolyte positioned between the cathode and the anode and configured to enable transport of lithium ions between the cathode and the anode,
wherein the anode comprises:
a current collector;
an anode active material layer comprising a polymer binder and particles containing lithium-aluminum alloy (LiAl) (hereinafter “LiAl-containing particles”),
wherein the anode active material layer has a first surface facing away from the current collector and a second surface facing the current collector;
wherein the closer to the second surface along a direction from the first surface to the second surface within the anode active material layer, generally the more lithium the LiAl-containing particles contain,
wherein the closer to the second surface along the direction within the anode active material layer, generally the smaller the LiAl-containing particles are, and
wherein the closer to the second surface along the direction within the anode active material layer, generally the less round the LiAl-containing particles are; and
wherein molecules of the polymer binder are distributed generally throughout the anode active material layer such that a portion of at least part of the molecules of the polymer binder is interposed between two adjacent LiAl-containing particles within the anode active material layer.
